(19) United States
(12) Patent Application Publication
(10) Pub. No.: US 2008/0254768 A1
(43) Pub. Date: Oct. 16, 2008

(54) Packet data network connectivity domain selection and bearer setup

(76) Inventor: Stefano Faccin, Fremont, CA (US)

Correspondence Address: HARNESS, DICKEY & PIERCE P.L.C., 5445 CORPORATE DRIVE, SUITE 200, TROY, MI, 48098, US

(21) Appl. No.: 12/152,300

(22) Filed: May 14, 2008

Related U.S. Application Data
(63) Continuation of application No. 12/101,519, filed on Apr. 11, 2008.
(60) Provisional application No. 60/911,377, filed on Apr. 12, 2007.
(60) Provisional application No. 60/942,032, filed on Jun. 5, 2007.

(51) Int. Cl. H04M 1/66; H04Q 7/20

(52) U.S. Cl. 455/411; 455/435.1

(57) ABSTRACT

A network device includes a receive module that receives a PDN descriptor that includes at least one of a PDN identifier and a PDN gateway identifier from a remote device before bearer setup of the remote device by the network device. A control module generates a reply signal that indicates the bearer setup based on the PDN descriptor. A transmit module transmits the reply signal to the remote device.

### CROSS-REFERENCE TO RELATED APPLICATIONS

This application is a continuation of U.S. patent application Ser. No. 12/101,519, filed Apr. 11, 2008, which claims the benefit of U.S. Provisional Application No. 60/911,377, filed on Apr. 12, 2007 and U.S. Provisional Application No. 60/942,032 filed on Jun. 5, 2007. The disclosures of the above applications are incorporated herein by reference in their entirety.

### FIELD

The present disclosure relates to communication systems, and more particularly to protocols for managing connectivity of network devices relative to remote networks.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

In the standardization of evolved 3^{rd} Generation Partnership Project (3GPP™) networks, 3GPP™ system architecture evolution (SAE) work is defining a new architecture where both evolved 3GPP™ wireless access (LTE—Long Term Evolution access) and non-3GPP™ accesses are considered. The technical specification (TS) 23.401 “3GPP™ GPRS enhancements for LTE access” [1] and the TS 23.402 “3GPP™ Architecture enhancements for non-3GPP™ accesses” [2], which are incorporated herein by reference in their entirety, contain the current definitions for the architecture and related mechanisms. Specifically, [1] covers one possible implementation of the SAE network supporting LTE, and [2] describes an alternative that supports both LTE and non-3GPP™ accesses. 3GPP™ requires an evolved 3GPP™ system to provide enhanced performance (e.g., low communication delay, low connection set-up time and high communication quality).

Traditionally in cellular networks (e.g. general packet radio service (GPRS), enhanced data rates for global system for mobile (GSM) evolution (EDGE), and third generation (3G)), a service request device (SRD) (e.g., a mobile network device) attaches to a network and is authenticated using a first procedure. After attachment and authentication, connectivity corresponding to the SRD is setup using a second procedure. This introduces a delay in access and reception of services and as a result limits network performance.

To prevent delays, a default system architecture evolution (SAE) bearer is defined by the 3^{rd} Generation Partnership Project (3GPP™) for both 3GPP™ access and non-3GPP™ access. For example, [1] states that a default SAE bearer is established during network attachment by an SRD to enable an “always-on IP connectivity” for an SRD. This default has been introduced in order to simplify and speed up the connectivity.

A visited public land mobile network (VPLMN) or a home PLMN (HPLMN) may select a network connectivity domain for the SRD and select services that the SRD obtains access to through the default SAE bearer. The network connectivity domain includes the selection of a packet data network (PDN) and a PDN SAE gateway. The SRD can gain IP connectivity via the PDN and the PDN SAE gateway. The VPLMN and/or the HPLMN may randomly provide this selection or may base the selection on, for example, network policies configured by a network operator (e.g. T-mobile™) or a SRD profile. The selections are referred to as default selections.

Access to different PDNs (e.g. 3GPP™ operator core services, enterprise connectivity, etc.) may require the selection of a different PDN SAE gateway then selected. To access a new (different) PDN, the SRD needs to request a new SAE bearer, which may refer to a set of addresses for an Internet session between the SRD and the new PDN. The SRD provides information that identifies the new PDN. This request introduces a delay, similar to the delay associated with the non-setup of a default bearer. A different PDN may be requested due to a difference in user requirements and/or application requirements and services provided by the selected connectivity domain. A different PDN may also be requested when the user of the SRD uses a terminal with different capabilities than a terminal that the HPLMN has associated with a profile of the user.

### SUMMARY

In one embodiment, a network device is provided that includes a packet data name (PDN) description generator that generates a PDN descriptor. The PDN descriptor includes at least one of a PDN identifier and a PDN gateway identifier. A transmit module transmits the PDN descriptor to a remote device before bearer setup of the network device by a remote network. A receive module receives a reply signal from the remote network that indicates the bearer setup based on the PDN descriptor. A control module communicates with a PDN gateway based on the reply signal.

In other features, the bearer setup includes at least one of attachment and Internet protocol (IP) connectivity setup of the network device. In other features, the attachment includes authentication and authorization of the network device. In other features, attachment includes at least one of generation of a bearer context, registration of the network device, and a binding update of the network device. In other features, the bearer context includes an address for an Internet session of the network device.

In other features, the IP connectivity setup includes at least one of a serving gateway, a packet data gateway, and a PDN gateway. In other features, the remote device communicates with the network device from the remote network. In other features, the PDN descriptor includes the PDN gateway identifier. The PDN gateway identifier identifies a PDN gateway in the remote network. In other features, the control module establishes a tunnel for communication with the PDN gateway based on the reply signal.

In other features, the PDN descriptor is indicative of a connectivity domain and Internet protocol services selected by the network device. In other features, the PDN descriptor includes an Internet protocol (IP) service identifier. In other features, the PDN descriptor includes an index value that is indicative of at least one of a PDN, a PDN gateway, PDN connection data, and bearer data. In other features, the control module generates a transfer function output based on the index value and generates the PDN descriptor based on the transfer function output.

In other features, the control module generates a transfer function output based on at least one of a PDN identifier, a PDN gateway identifier, and an Internet service identifier. The control module generates the PDN descriptor based on the transfer function output. In other features, the transfer function includes a hashing transfer function. In other features, the control module generates an index value based on the transfer function output. The control module generates the PDN descriptor based on the index value.

In other features, the transmit module transmits at least one of an access point name and a domain name that includes the PDN descriptor, and the receive module receives the reply signal based on at least one of the access point name and the domain name.

In other features, the transmit module transmits the PDN descriptor during an attachment procedure of the network device. In other features, the control module generates an attachment request signal that includes the PDN descriptor and transmits the attachment request signal to the remote network before reception of an identity request from a mobility management entity.

In other features, the control module generates an attachment request signal that includes the PDN descriptor and transmits the attachment request signal to the remote network, and the receive module receives an attachment accept signal from the remote network based on the attachment request signal.

In other features, the transmit module transmits the PDN descriptor during authentication of the network device by the remote network. In other features, the transmit module transmits the PDN descriptor during a registration of the network device with the remote network. In other features, the receive module receives at least one of a registration reply signal and a binding acknowledgement signal based on the PDN descriptor.

In other features, a network system includes the network device and further includes a remote device that generates the reply signal based on the PDN generator. In other features, the remote device generates the reply signal based on selection of at least one of a PDN and a PDN gateway corresponding to the PDN identifier and the PDN gateway identifier.

In other features, the network system further includes the PDN gateway. The network device is in communication with the PDN gateway based on the bearer setup.

In other features, a network device is provided that includes a receive module that receives a PDN descriptor that includes at least one of a PDN identifier and a PDN gateway identifier from a remote device. The PDN descriptor is received before bearer setup of the remote device by the network device. A control module generates a reply signal that indicates the bearer setup based on the PDN descriptor. A transmit module transmits the reply signal to the remote device.

In other features, the bearer setup includes at least one of attachment and Internet protocol (IP) connectivity setup of the remote device. In other features, the attachment includes authentication and authorization of the network device. In other features, the attachment includes at least one of generation of a bearer context, registration of the network device, and a binding update of the remote device. In other features, the bearer context includes an address for an Internet session of the remote device.

In other features, the IP connectivity setup includes at least one of a serving gateway, a packet data gateway, and a PDN gateway. In other features, the control module enables the bearer setup based on selection of at least one of a PDN and a PDN gateway, and the selection is based on the PDN descriptor.

In other features, the control module includes at least one of a mobility management entity control module, a serving gateway control module, and a home subscriber server control module. The control module selects at least one of the PDN and the PDN gateway based on the PDN descriptor.

In other features, the PDN descriptor includes the PDN gateway identifier; and the PDN gateway identifier identifies a PDN gateway in a network of the network device. In other features, the control module establishes a tunnel for communication with the PDN gateway based on the reply signal.

In other features, the PDN descriptor is indicative of a connectivity domain and Internet protocol services selected by the network device. In other features, the PDN descriptor includes an Internet protocol (IP) service identifier. In other features, the PDN descriptor includes an index value. The control module determines at least one of a PDN, a PDN gateway, PDN connection data, and bearer data based on the index value.

In other features, the receive module receives a transfer function output based on an index value. The control module determines at least one of a PDN, a PDN gateway, PDN connection data, and bearer data based on the transfer function output.

In other features, the receive module receives a transfer function output based on at least one of a PDN identifier, a PDN gateway identifier, and an Internet service identifier. The control module determines at least one of a PDN, a PDN gateway, PDN connection data, and bearer data based on the transfer function output.

In other features, the transfer function includes a hashing transfer function. In other features, the receive module receives an index value based on the transfer function value. The control module determines at least one of a PDN, a PDN gateway, PDN connection data, and bearer data based on the index value.

In other features, the receive module receives at least one of an access point name and a domain name that includes the PDN descriptor. The transmit module transmits the reply signal based on at least one of the access point name and the domain name.

In other features, the receive module receives the PDN descriptor during an attachment procedure of the remote device. In other features, the control module generates a bearer context request based on the PDN descriptor. The transmit module transmits the bearer context request to at least one of a serving gateway and a PDN gateway. The receive module receives a bearer context response based on the bearer context request signal.

In other features, the receive module receives an attachment request signal that includes the PDN descriptor. The transmit module transmits an attachment accept signal generated by a mobility management entity based on the attachment request signal.

In other features, the receive module receives the PDN descriptor during authentication of the remote device by a network that is remote to the remote device. In other features, the receive module receives the PDN descriptor during a registration of the remote device with the network device.

In other features, the transmit module transmits a registration reply signal based on selection of at least one of a PDN and a PDN gateway corresponding to identifiers of the PDN descriptor. In other features, the transmit module transmits a binding acknowledgement signal based on selection of at least one of a PDN and a PDN gateway corresponding to identifiers of the PDN descriptor.

In other features, a method of operating a network device is provided and includes generating a PDN descriptor that includes at least one of a PDN identifier and a PDN gateway identifier. The PDN descriptor is transmitted to a remote device before bearer setup of the network device by a remote network. A reply signal is received from the remote network that indicates the bearer setup based on the PDN descriptor. A PDN gateway is communicated with based on the reply signal.

In other features, the bearer setup includes at least one of attachment and Internet protocol (IP) connectivity setup of the network device. In other features, the attachment includes authentication and authorization of the network device. In other features, the attachment includes at least one of generation of a bearer context, registration of the network device, and a binding update of the network device.

In other features, the bearer context includes an address for an Internet session of the network device. In other features, the IP connectivity setup includes at least one of a serving gateway, a packet data gateway, and a PDN gateway. In other features, the remote device communicates with the network device from the remote network.

In other features, the PDN descriptor includes the PDN gateway identifier; and the PDN gateway identifier identifies a PDN gateway in the remote network. In other features, a tunnel is established for communication with the PDN gateway based on the reply signal.

In other features, the PDN descriptor is indicative of a connectivity domain and Internet protocol services selected by the network device. In other features, the PDN descriptor includes an Internet protocol (IP) service identifier.

In other features, the PDN descriptor includes an index value that is indicative of at least one of a PDN, a PDN gateway, PDN connection data, and bearer data. In other features, the method further includes generating a transfer function output based on the index value and generating the PDN descriptor based on the transfer function output.

In other features, the method further includes generating a transfer function output based on at least one of a PDN identifier, a PDN gateway identifier, and an Internet service identifier. The PDN descriptor is generated based on the transfer function output. In other features, the transfer function includes a hashing transfer function. In other features, the method further includes generating an index value based on the transfer function output; and generating the PDN descriptor based on the index value.

In other features, the method further includes transmitting at least one of an access point name and a domain name that includes the PDN descriptor. The reply signal is received based on at least one of the access point name and the domain name.

In other features, the method further includes transmitting the PDN descriptor during an attachment procedure of the network device. In other features, the method further includes generating an attachment request signal that includes the PDN descriptor. The attachment request signal is transmitted to the remote network before reception of an identity request from a mobility management entity.

In other features, the method further includes generating an attachment request signal that includes the PDN descriptor and transmitting the attachment request signal to the remote network. An attachment accept signal is received from the remote network based on the attachment request signal.

In other features, the method further includes transmitting the PDN descriptor during authentication of the network device by the remote network. In other features, the method further includes transmitting the PDN descriptor during a registration of the network device with the remote network.

In other features, the method further includes receiving at least one of a registration reply signal and a binding acknowledgement signal based on the PDN descriptor. In other features, the method further includes generating the reply signal based on the PDN generator via a remote device. In other features, the remote device generates the reply signal based on selection of at least one of a PDN and a PDN gateway corresponding to the PDN identifier and the PDN gateway identifier.

In other features, a method of operating a network device is provided and includes receiving a PDN descriptor that includes at least one of a PDN identifier and a PDN gateway identifier from a remote device. The PDN descriptor is received before bearer setup of the remote device by the network device. A reply signal is generated that indicates the bearer setup based on the PDN descriptor. The reply signal is transmitted to the remote device.

In other features, the bearer setup includes at least one of attachment and Internet protocol (IP) connectivity setup of the remote device. In other features, the attachment includes authentication and authorization of the network device. In other features, the attachment includes at least one of generation of a bearer context, registration of the network device, a binding update of the remote device. In other features, the bearer context includes an address for an Internet session of the remote device.

In other features, the IP connectivity setup includes at least one of a serving gateway, a packet data gateway, and a PDN gateway. In other features, the method further includes enabling the bearer setup based on selection of at least one of a PDN and a PDN gateway. The selection is based on the PDN descriptor.

In other features, the method further includes selecting at least one of the PDN and the PDN gateway based on the PDN descriptor. In other features, the PDN descriptor includes the PDN gateway identifier. The PDN gateway identifier identifies a PDN gateway in a network of the network device. In other features, the method further includes establishing a tunnel for communication with the PDN gateway based on the reply signal.

In other features, the PDN descriptor is indicative of a connectivity domain and Internet protocol services selected by the network device. In other features, the PDN descriptor includes an Internet protocol (IP) service identifier. In other features, the method further includes determining at least one of a PDN, a PDN gateway, PDN connection data, and bearer data based on the index value, the PDN descriptor includes an index value.

In other features, the method further includes receiving a transfer function output based on an index value. At least one of a PDN, a PDN gateway, PDN connection data, and bearer data is determined based on the transfer function output.

In other features, the method further includes receiving a transfer function output based on at least one of a PDN identifier, a PDN gateway identifier, and an Internet service identifier. At least one of a PDN, a PDN gateway, PDN connection data, and bearer data is determined based on the transfer function output.

In other features, the transfer function includes a hashing transfer function. In other features, the method further includes receiving an index value based on the transfer function value. At least one of a PDN, a PDN gateway, PDN connection data, and bearer data is determined based on the index value.

In other features, the method further includes receiving at least one of an access point name and a domain name that includes the PDN descriptor. The reply signal is transmitted based on at least one of the access point name and the domain name.

In other features, the method further includes receiving the PDN descriptor during an attachment procedure of the remote device. In other features, the method further includes generating a bearer context request based on the PDN descriptor. The bearer context request is transmitted to at least one of a serving gateway and a PDN gateway. A bearer context response is received based on the bearer context request signal.

In other features, the method further includes receiving an attachment request signal that includes the PDN descriptor. An attachment accept signal generated by a mobility management entity is transmitted based on the attachment request signal.

In other features, the method further includes receiving the PDN descriptor during authentication of the remote device by a network that is remote to the remote device. In other features, the method further includes receiving the PDN descriptor during a registration of the remote device with the network device.

In other features, the method further includes transmitting a registration reply signal based on selection of at least one of a PDN and a PDN gateway corresponding to identifiers of the PDN descriptor. In other features, the method further includes transmitting a binding acknowledgement signal based on selection of at least one of a PDN and a PDN gateway corresponding to identifiers of the PDN descriptor.

In other features, a network device is provided that includes PDN description means for generating a PDN descriptor. The PDN descriptor includes at least one of a PDN identifier and a PDN gateway identifier. Transmitting means transmits the PDN descriptor to a remote device before bearer setup of the network device by a remote network. Receiving means receives a reply signal from the remote network that indicates the bearer setup based on the PDN descriptor. Control means communicates with a PDN gateway based on the reply signal.

In other features, the bearer setup includes at least one of attachment and Internet protocol (IP) connectivity setup of the network device. In other features, the attachment includes authentication and authorization of the network device. In other features, the attachment includes at least one of generation of a bearer context, registration of the network device, a binding update of the network device. In other features, the bearer context includes an address for an Internet session of the network device. In other features, the IP connectivity setup includes at least one of a serving gateway, a packet data gateway, and a PDN gateway.

In other features, the remote device communicates with the network device from the remote network. In other features, the PDN descriptor includes the PDN gateway identifier; and the PDN gateway identifier identifies a PDN gateway in the remote network. In other features, the control means establishes a tunnel for communication with the PDN gateway based on the reply signal.

In other features, the PDN descriptor is indicative of a connectivity domain and Internet protocol services selected by the network device. In other features, the PDN descriptor includes an Internet protocol (IP) service identifier. In other features, the PDN descriptor includes an index value that is indicative of at least one of a PDN, a PDN gateway, PDN connection data, and bearer data. In other features, the control means generates a transfer function output based on the index value and generates the PDN descriptor based on the transfer function output.

In other features, the control means generates a transfer function output based on at least one of a PDN identifier, a PDN gateway identifier, and an Internet service identifier, and the control means generates the PDN descriptor based on the transfer function output. In other features, the transfer function includes a hashing transfer function.

In other features, the control means generates an index value based on the transfer function output, and the control means generates the PDN descriptor based on the index value. In other features, the transmitting means transmits at least one of an access point name and a domain name that includes the PDN descriptor, and the receiving means receives the reply signal based on at least one of the access point name and the domain name.

In other features, the transmitting means transmits the PDN descriptor during an attachment procedure of the network device. In other features, the control means generates an attachment request signal that includes the PDN descriptor and transmits the attachment request signal to the remote network before reception of an identity request from a mobility management entity.

In other features, the control means generates an attachment request signal that includes the PDN descriptor and transmits the attachment request signal to the remote network. The receiving means receives an attachment accept signal from the remote network based on the attachment request signal.

In other features, the transmitting means transmits the PDN descriptor during authentication of the network device by the remote network. In other features, the transmitting means transmits the PDN descriptor during a registration of the network device with the remote network.

In other features, the receiving means receives at least one of a registration reply signal and a binding acknowledgement signal based on the PDN descriptor. In other features, a network system is provided and includes the network device and further includes a remote device that generates the reply signal based on the PDN generator.

In other features, the remote device generates the reply signal based on selection of at least one of a PDN and a PDN gateway corresponding to the PDN identifier and the PDN gateway identifier. In other features, the network system further includes the PDN gateway. The network device is in communication with the PDN gateway based on the bearer setup.

In other features, a network device is provided and includes receiving means for receiving a PDN descriptor that includes at least one of a PDN identifier and a PDN gateway identifier from a remote device. The PDN descriptor is received before bearer setup of the remote device by the network device. Control means generates a reply signal that indicates the bearer setup based on the PDN descriptor. Transmitting means transmits the reply signal to the remote device.

In other features, the bearer setup includes at least one of attachment and Internet protocol (IP) connectivity setup of the remote device. In other features, the attachment includes authentication and authorization of the network device. In other features, the attachment includes at least one of generation of a bearer context, registration of the network device, a binding update of the remote device.

In other features, the bearer context includes an address for an Internet session of the remote device. In other features, the IP connectivity setup includes at least one of a serving gateway, a packet data gateway, and a PDN gateway. In other features, the control means enables the bearer setup based on selection of at least one of a PDN and a PDN gateway. The selection is based on the PDN descriptor.

In other features, the control means includes at least one of a mobility management entity control module, a serving gateway control module, and a home subscriber server control module. The control means selects at least one of the PDN and the PDN gateway based on the PDN descriptor.

In other features, the PDN descriptor includes the PDN gateway identifier. The PDN gateway identifier identifies a PDN gateway in a network of the network device.

In other features, the control means establishes a tunnel for communication with the PDN gateway based on the reply signal. In other features, the PDN descriptor is indicative of a connectivity domain and Internet protocol services selected by the network device. In other features, the PDN descriptor includes an Internet protocol (IP) service identifier.

In other features, the PDN descriptor includes an index value. The control means determines at least one of a PDN, a PDN gateway, PDN connection data, and bearer data based on the index value.

In other features, the receiving means receives a transfer function output based on an index value. The control means determines at least one of a PDN, a PDN gateway, PDN connection data, and bearer data based on the transfer function output.

In other features, the receiving means receives a transfer function output based on at least one of a PDN identifier, a PDN gateway identifier, and an Internet service identifier. The control means determines at least one of a PDN, a PDN gateway, PDN connection data, and bearer data based on the transfer function output. In other features, the transfer function includes a hashing transfer function.

In other features, the receiving means receives an index value based on the transfer function value. The control means determines at least one of a PDN, a PDN gateway, PDN connection data, and bearer data based on the index value.

In other features, the receiving means receives at least one of an access point name and a domain name that includes the PDN descriptor. The transmitting means transmits the reply signal based on the at least one of an access point name and a domain name. In other features, the receiving means receives the PDN descriptor during an attachment procedure of the remote device.

In other features, the control means generates a bearer context request based on the PDN descriptor. The transmitting means transmits the bearer context request to at least one of a serving gateway and a PDN gateway. The receiving means receives a bearer context response based on the bearer context request signal.

In other features, the receiving means receives an attachment request signal that includes the PDN descriptor. The transmitting means transmits an attachment accept signal generated by a mobility management entity based on the attachment request signal.

In other features, the receiving means receives the PDN descriptor during authentication of the remote device by a network that is remote to the remote device. In other features, the receiving means receives the PDN descriptor during a registration of the remote device with the network device.

In other features, the transmitting means transmits a registration reply signal based on selection of at least one of a PDN and a PDN gateway corresponding to identifiers of the PDN descriptor. In other features, the transmitting means transmits a binding acknowledgement signal based on selection of at least one of a PDN and a PDN gateway corresponding to identifiers of the PDN descriptor.

In still other features, the systems and methods described above are implemented by a computer program executed by one or more processors. The computer program can reside on a computer readable medium such as but not limited to memory, non-volatile data storage and/or other suitable tangible storage mediums.

Further areas of applicability of the present disclosure will become apparent from the detailed description provided hereinafter. It should be understood that the detailed description and specific examples, are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an exemplary network system in accordance with an embodiment of the present disclosure;

FIG. 2 is a functional block diagram of an exemplary network system illustrating non-roaming access via a radio access network in accordance with an embodiment of the present disclosure;

FIG. 3 is a functional block diagram of an exemplary network system illustrating roaming access via a radio access network in accordance with an embodiment of the present disclosure;

FIG. 4 is a functional block diagram of another exemplary network system in accordance with an embodiment of the present disclosure;

FIG. 5 is a flow diagram illustrating a method of managing connectivity for wireless access in a network that supports long term evolution in accordance with an embodiment of the present disclosure;

FIG. 6 is a message flow diagram illustrating the management method of FIG. 5;

FIG. 7 is a functional block diagram of an exemplary network system for trusted and untrusted non-roaming access in accordance with an embodiment of the present disclosure;

FIG. 8 is a functional block diagram of an exemplary network system for trusted and untrusted roaming access in accordance with an embodiment of the present disclosure;

FIG. 9 is a flow diagram illustrating a method of managing connectivity for wireless access in a network for trusted access using a host-based mobility protocol in accordance with an embodiment of the present disclosure;

FIG. 10 is a message flow diagram illustrating the management method of FIG. 9;

FIG. 11 a flow diagram illustrating a method of managing connectivity for wireless access in a network for trusted access using a network-based mobility protocol in accordance with an embodiment of the present disclosure;

FIG. 12 is a message flow diagram illustrating the management method of FIG. 11;

FIG. 13 is a functional block diagram of another exemplary network system in accordance with an embodiment of the present disclosure

FIG. 14 is a flow diagram illustrating a method of managing connectivity for wireless access in a network for untrusted access using a network-based mobility protocol in accordance with an embodiment of the present disclosure;

FIG. 15 is a message flow diagram illustrating the management method of FIG. 14;

FIG. 16 is a flow diagram illustrating a method of managing connectivity for wireless access in a network for untrusted access using a host-based mobility protocol in accordance with an embodiment of the present disclosure;

FIG. 17 is a message flow diagram illustrating the management method of FIG. 16;

FIG. 18 is a block diagram of an exemplary access point name in accordance with an embodiment of the present disclosure;

FIG. 19 is a block diagram of an exemplary fully qualified domain name in accordance with an embodiment of the present disclosure;

FIG. 20 is a block diagram of an exemplary fully qualified domain name in accordance with another embodiment of the present disclosure;

FIG. 21 is a logic flow diagram illustrating a method of providing a PDN descriptor in accordance with an embodiment of the present disclosure;

FIG. 22A is a functional block diagram of a high definition television;

FIG. 22B is a functional block diagram of a vehicle control system;

FIG. 22C is a functional block diagram of a cellular phone;

FIG. 22D is a functional block diagram of a set top box; and

FIG. 22E is a functional block diagram of a mobile device.

### DETAILED DESCRIPTION

The following description is merely exemplary in nature and is in no way intended to limit the disclosure, its application, or uses. For purposes of clarity, the same reference numbers will be used in the drawings to identify similar elements. As used herein, the phrase at least one of A, B, and C should be construed to mean a logical (A or B or C), using a non-exclusive logical or. It should be understood that steps within a method may be executed in different order without altering the principles of the present disclosure.

As used herein, the term module refers to an Application Specific Integrated Circuit (ASIC), an electronic circuit, a processor (shared, dedicated, or group) and memory that execute one or more software or firmware programs, a combinational logic circuit, and/or other suitable components that provide the described functionality.

In the following description, a service request device (SRD) may refer to user equipment (UE) and/or a mobile node. A SRD may include equipment of an end user, such as a processor, a radio interface adaptor, etc. An SRD may include a mobile network device, a personal data assistant (PDA), a computer, etc.

Also, in the following description, the term mobility protocol may include a local mobility protocol and/or a global mobility protocol. A local mobility protocol may refer to a communication protocol used for mobility by a SRD between access points of a network, such as a public land mobile network (PLMN). The access points are in communication with different access routers. A global mobility protocol refers to a communication protocol used for mobility by a SRD between access points of different networks. The different networks may be different PLMNs.

A mobility protocol may include a mobile Internet protocol (MIP), which may refer to a host-based Internet protocol (IP) or a network-based IP. Internet Engineering Task Force (IETF) RFC 3344 and IETF RFC 3775 are incorporated herein by reference in their entirety. A host-based IP may include a client mobile IP (CMIP), such as CMIPv4 and CMIPv6, or a dual stack mobile IP (DSMIP). A host-based IP is used when mobility management is handled by a SRD. A network-based IP may include a proxy MIP (PMIP), such as PMIPv4 and PMIPv6. A network-based IP may be used, for example, when mobility management is handled by a mobility management entity (MME) or other network device on behalf of a SRD.

In addition, in the following description various networks and network devices are disclosed. Although a particular number of each network device is shown, any number of each network device may be included. For example, in a home network and or a visited network any number of wireless access gateways (WAGs), home subscriber servers (HSSs), authentication authorization and accounting (AAA) servers, etc. may be included. Selection of one of each of the devices may be performed during communication with a SRD. Each of the network devices may be considered a remote network device relative to another network device.

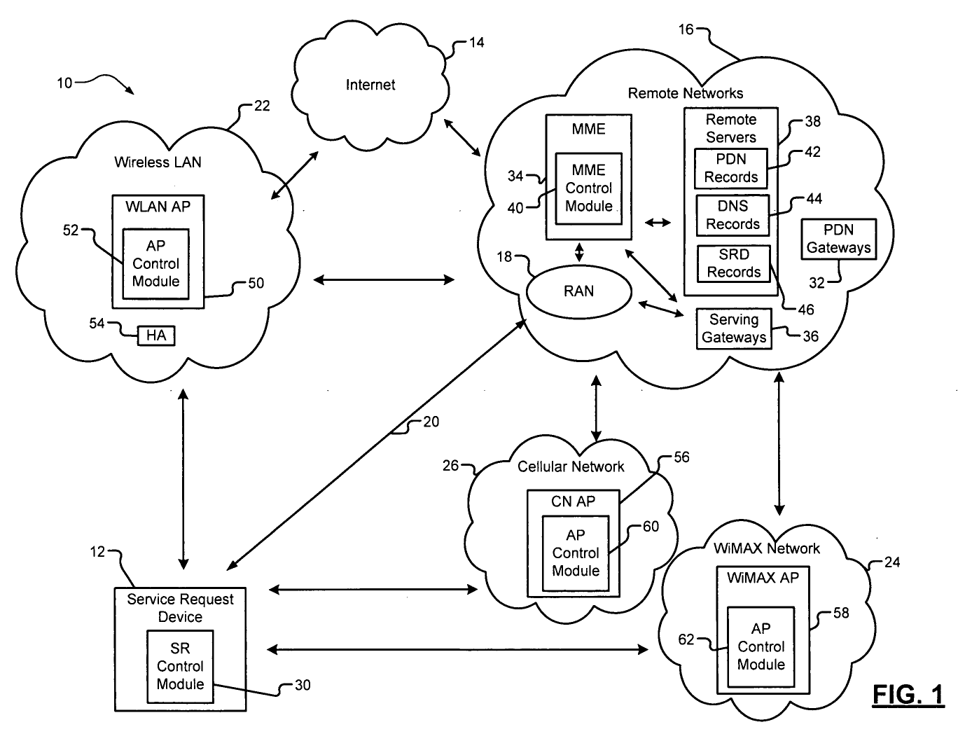

The following systems of FIGS. 1-4, 7, 8, and 13 may include 3GPP™ system networks and comply with 3GPP™ system technical specifications, some of which are stated herein.

Referring now to FIG. 1, an exemplary network system 10 is shown. The network system 10 includes a SRD 12 that may communicate with the Internet 14 and/or one or more remote networks 16. The SRD 12 may communicate with a radio access network (RAN) 18, such as an evolved universal terrestrial radio access network (EUTRAN) of the remote networks 16 as indicated by signal line 20 or may communicate with the remote networks 16 via an access network. Some examples of an access network are a wireless local area network (WLAN) 22, a Worldwide Interoperability for Microwave Access (WiMAX) network 24, and a cellular network 26.

The network system 10 provides connectivity and/or mobility management. The connectivity management is provided in an efficient manner using one or more of the techniques described herein. Mobility management allows the SRD 12 to move between local and/or global networks. The mobility may be provided through establishment of Internet protocol (IP) connectivity between the SRD 12 and the remote networks 16.

The SRD 12 includes a service request control module 30 that provides connectivity protocol information to the remote networks 16. The service request control module 30 may identify a packet data network (PDN) gateway, such as one of the PDN gateways 32, of the remote networks 16 to provide requested services. The SRD 12 accesses packet switched domain services via the selected PDN gateway. The PDN gateway may be located in a home PLMN (HPLMN). The SRD 12 may request various real-time and non-real-time services, such as Web browsing, voice over Internet phone (VoIP), electronic mail (email), and real-time IP multimedia, as well as conversational and streaming services.

The remote networks 16 may include 3GPP™ system networks, a VPLMN, a HPLMN, etc. The remote networks 16 may comply with [1], [2], TS 22.278 “3GPP™ Service requirements for the evolved packet system (EPS)”, TS 23.060 “General Packet Radio Service (GPRS) service description”, which are incorporated herein by reference in their entirety. The remote networks 16 may include the RAN 18, the PDN gateways 32, a MME 34, serving gateways 36, and remote servers 38, such as home subscriber servers (HSSs). The MME 34 may include a MME control module 40 that supports connectivity and/or mobility of the SRD 12. The serving gateways 36 may include system architecture evolution (SAE) gateways. The remote servers 38 may include PDN records 42, DNS records 44, and SRD records 46. The PDN records 42 include information regarding the services, connectivity protocols, and mobility protocols supported by the PDN gateways 32. The DNS records 44 include information regarding the services and connectivity protocols supported by packet data gateways (PDGs). The DNS records 44 may also include mobility protocols supported by the PDGs. The SRD records 46 include information regarding the subscriber and account associated with the SRD 12.

Each of the PDN gateways 32 may have a physical address (effective address) and/or one or more logical addresses, which are referred to as remote IP addresses. Each remote IP address may have an associated service and connectivity and mobility protocol and be assigned to the SRD 12. For example only, a remote IP address may be associated with home-based IP CMIPv6 and be used to provide VoIP service to the SRD 12.

When the SRD 12 initially accesses the network system 10, the MME 34, the PDN gateways 32, the serving gateways 36, and the remote servers 38 are unaware of the SRD preferred PDN, PDN gateway, and IP services. The MME 34, the PDN gateways 23, the serving gateways 36 and the remote servers 38 may support multiple connectivity protocols and services. The embodiments described herein include the SRD 12 providing PDN, PDN gateway and IP services information early on in an attachment process. This improves network performance and quickly provides the services desired by the SRD.

The WLAN 22 includes a WLAN access point (AP) 50 with an AP control module 52. The WLAN AP 50, for example, may be a base station, such as an evolved node B base station (eNodeB). The WLAN 50 may also include one or more home agents 54, such as routers. The AP mobility control module 52 facilitates authentication of the SRD 12 and the transfer of connectivity protocol information, mobility protocol information, PDN information, PDN gateway information, and IP services information between the SRD 12 and network devices of the remote networks. The WLAN 22 may comply with one or more IEEE standards 802.11, 802.11a, 802.11b, 802.11g, 802.11h, 802.11n, 802.16, and 802.20, which are incorporated herein by reference in their entirety.

The cellular network 26 and the WiMAX network 24 may include a cellular network AP 56 and a WiMAX network AP 58 with respective AP control modules 60, 62, as shown. The AP control modules 56, 58 may also facilitate authentication of the SRD 12 and the transfer of connectivity and mobility protocol information, and PDN gateway information between the SRD 12 and network devices of the remote networks 16.

During operation, the SRD 12 may move or roam between the networks 22, 24, 26 without losing connection to one or more of the remote networks 16. When in communication with the RAN 18, IP traffic flows between the RAN 18 and the serving gateways 36. When in communication with the networks 22, 24, 26, IP traffic flows between the networks 22, 24, 26 and the serving gateways 36.

When the SRD 12 accesses the remote networks 16 while roaming between the networks 22, 24, 26, connectivity and mobility tunnels, may be used to manage and maintain connectivity and mobility of the SRD 12. When the SRD 12 switches between different networks, a host-based system or a network-based system may be used to establish a connectivity tunnel and/or a mobility tunnel. The connectivity tunnel may be a secured IP tunnel.

The host-based system may utilize CMIP or DSMIP protocols. CMIP versions 4 and 6 are described in IP mobility request for support memos RFC 3344 and in RFC. 3775, which are incorporated herein by reference in their entirety. DSMIPv6 is described in “Mobile IPv6 support for dual stack, Hosts, and Routers (DSMIPv6)” of an Internet draft by the IPv6 working group of IETF, which is incorporated herein by reference in its entirety. The network-based system may utilize PMIP protocols. PMIP version 4 is described in an Internet-Draft titled “Mobility Management using Proxy Mobile IPv4” by Leung et al. and PMIPv6 is described in “Localized Mobility Management using Proxy Mobile IPv6” by Gundavelli, which are incorporated herein by reference in their entirety.

When a host-based protocol associated with version 4 networks, such as CMIPv4, is used, a serving gateway may function as a foreign agent (FA) and provide routing services to the SRD 12. This may occur when the SRD 12 is registered with the PDN gateway. The PDN gateway performs as a home agent. The SRD 12 may receive IP configuration information contained in an agent advertisement message through CMIPv4 or link layer protocols.

When a host-based protocol associated with a version 6 network, such as CMIPv6, is used, a serving gateway may function as an access router and provide routing services to the SRD 12. The PDN gateway performs as a home agent. The SRD 12 may receive IP configuration information contained in a CMIPv6 router advertisement message through CMIPv6 or link layer protocols.

When a network-based protocol is used, a serving gateway may function as a PMIP client (i.e., a PMIP agent (PMA)). The PDN gateway performs as a PMIP home agent. A PMIP client allocates a SRD IP address and provides the SRD IP address to the SRD 12. The PMIP client performs PMIP mobility procedures.

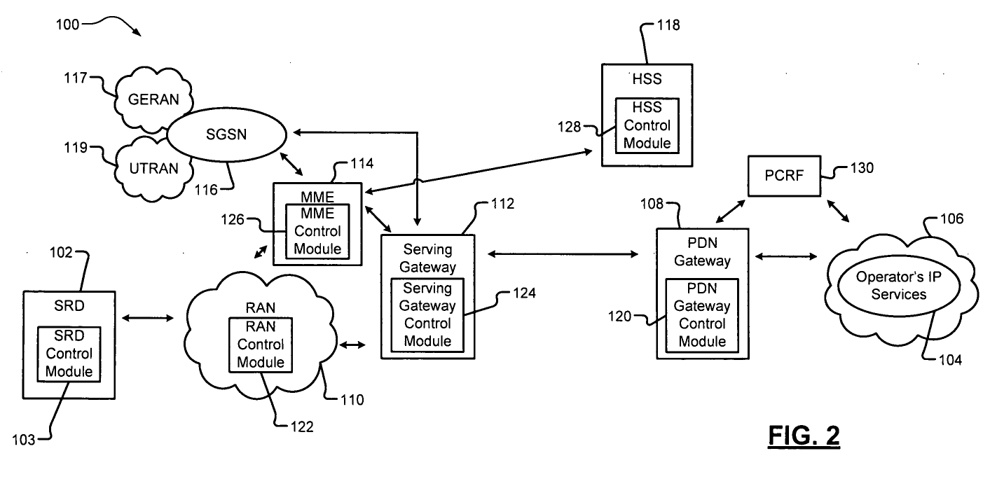

Referring now to FIG. 2, an exemplary network system 100 illustrating non-roaming 3GPP™ access from a 3GPP™ network is shown. The network system 100 includes a SRD 102 with an SRD control module 103 that obtains network access to receive services, such as operator IP services 104, from a PDN 106. The SRD 102 establishes Internet protocol (IP) connectivity with a PDN gateway 108 to receive the services 104. The services 104 may include real-time and non-real-time services, such as Web browsing, voice over Internet phone (VoIP), electronic mail (email), and IP multimedia subsystem (IMS) services, packet switched service sequence (PSS) services, conversational and streaming services, etc.

The network system 100 may include the PDN gateway 108, an EUTRAN 110, a serving gateway 112, a mobility management entity (MME) 114, a servicing general packet radio service support node (SGSN) 116, and a home subscriber server (HSS) 118. The SGSN 116 may be in communication with a GSM EDGE RAN (GERAN) 117 and/or a universal terrestrial RAN (UTRAN) 119. The UTRAN 119 may be the same as the EUTRAN 110 or may be another RAN. The PDN gateway 108, the EUTRAN 110, the serving gateway 112, the MME 114, and the home subscriber server 118 respectively include a PDN gateway control module 120, a EUTRAN control module 122, a serving gateway control module 124, a MME control module 126, and a HSS control module 128.

The PDN gateway 108 is in communication with a policy and changing rules function (PCRF) entity 130 and the PDN 106. The PCRF entity 130 may be used to terminate reference points between network devices, such as reference points associated with the serving gateway 112 and the PCRF entity 130. Reference points refer to communication links between network devices.

The serving gateway 112 may be a SAE gateway or a wireless access gateway (WAG). The MME 114 is in communication with each of the EUTRAN 110, the serving gateway 112, the SGSN 116, and the HSS 118. The MME 114 performs SRD tracking and security functions. The serving gateway 112 is in communication with the PDN gateway 108, the EUTRAN 110, and the SGSN 116. The SGSN 116 may perform MME selection and/or serving gateway selection.

The HSS 118 may have authentication and subscriber profile information, such as for a subscriber of the SRD 102, to access the PDN 106. The HSS 118, the MME 114, and/or the serving gateway 124 may perform PDN, PDN gateway, and IP services selections. The selections may be based on PDN, PDN gateway, and IP service information provided by the SRD 102. For example only, the HSS 118, may authenticate the subscriber after an invoked tunnel establishment request by the SRD 102.

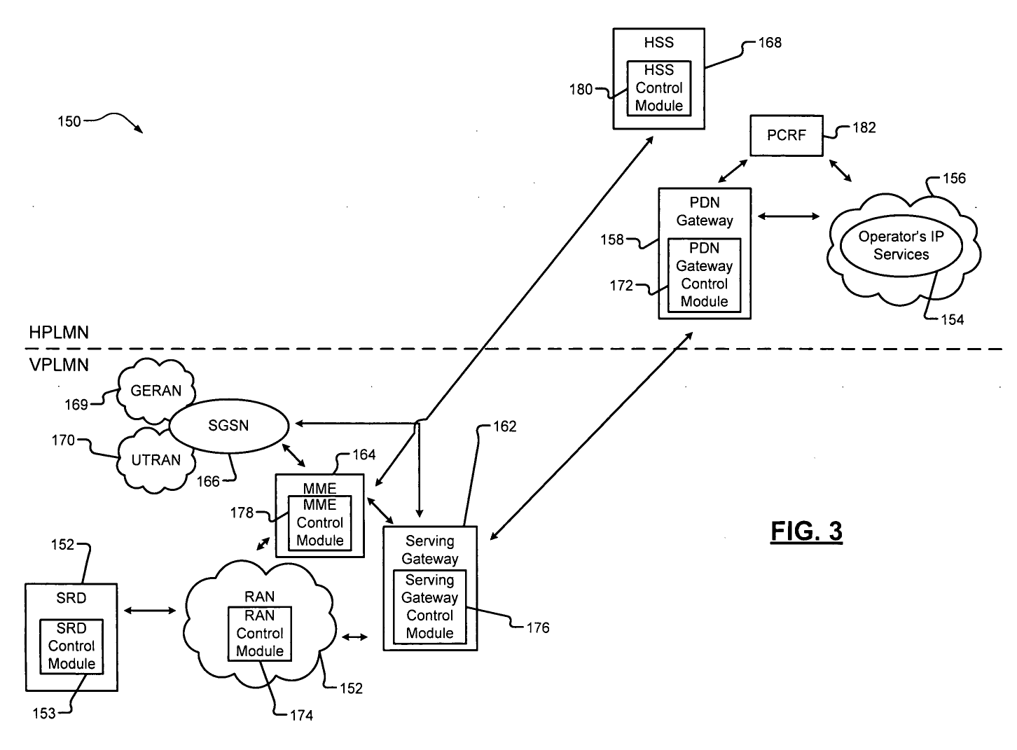

Referring now to FIG. 3, an exemplary network system 150 illustrating roaming access via a EUTRAN 152 is shown. The network system 150 includes a SRD 152 with an SRD control module 153 that obtains network access to receive services, such as operator IP services 154, from a PDN 156. The PDN 156 may be part of a HPLMN, whereas the SRD 152 is located in a VPLMN. The SRD 152 establishes IP connectivity with a PDN gateway 158 to receive the services 154.

The network system 150 may include the EUTRAN 152, the PDN gateway 158, a serving gateway 162, a MME 164, a SGSN 166, and a HSS 168. The SGSN 166 may be in communication with a GERAN 169 and/or an UTRAN 170. The UTRAN 170 may be the same as the EUTRAN 152 or may be another RAN. The PDN gateway 158, the EUTRAN 152, the serving gateway 162, the MME 164, and the home subscriber server 168 respectively include a PDN gateway control module 172, a EUTRAN control module 174, a serving gateway control module 176, a MME control module 178, and a HSS control module 180.

The PDN gateway 158 is in communication with a PCRF entity 182 and the PDN 156. The PCRF entity 182 may be used to terminate reference points between network devices, such as reference points associated with the serving gateway 162 and the PCRF entity 182.

The serving gateway 162 may be a SAE gateway or a wireless access gateway (WAG). The MME 164 is in communication with each of the EUTRAN 152, the serving gateway 162, the SGSN 166, and the HSS 168. The MME 164 performs SRD tracking and security functions. The serving gateway 162 is in communication with the PDN gateway 158, the EUTRAN 152, and the SGSN 166. The SGSN 166 may perform MME selection and/or serving gateway selection.

The HSS 168 may have authentication and subscriber profile information, such as for a subscriber of the SRD 152, to access the PDN 156. The HSS 168, the MME 164, and/or the serving gateway 162 may perform PDN, PDN gateway, and IP services selections. The selections may be based on PDN, PDN gateway, and IP service information provided by the SRD 152. For example only, the HSS 168, may authenticate the subscriber after an invoked tunnel establishment request by the SRD 152.

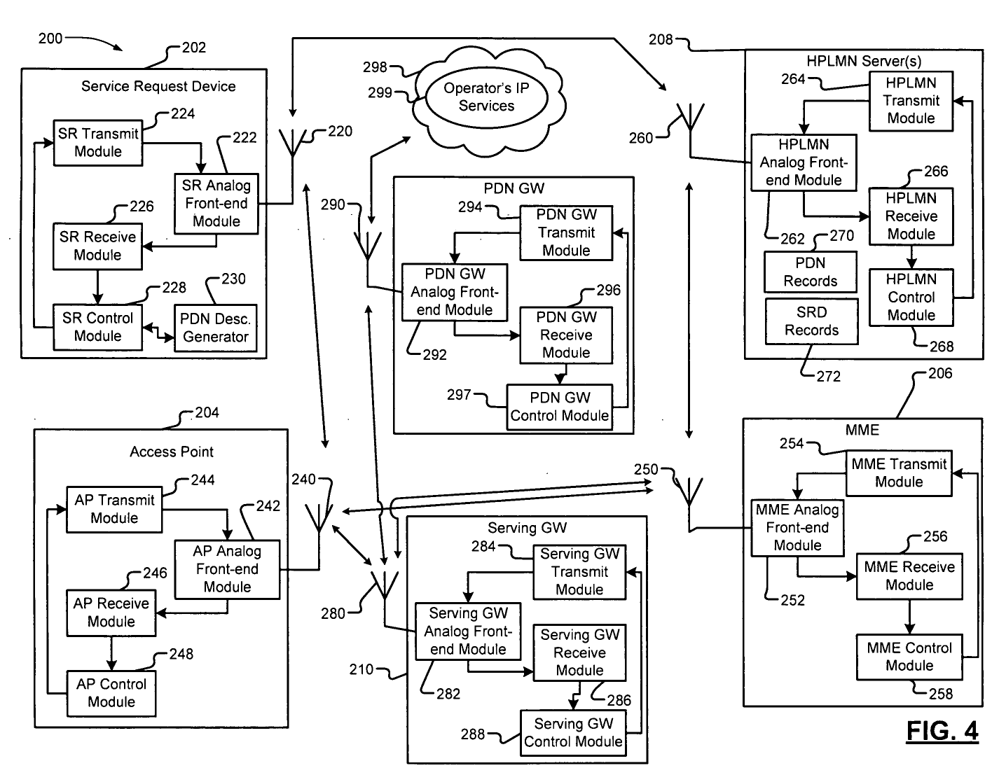

Referring now to FIG. 4, a functional block diagram of another exemplary network system 200 is shown. The exemplary network system 200 is shown. The network system 200 includes a SRD 202, an AP 204, a MME 206, and HPLMN server(s) 208. The AP 204 may include a RAN, a WLAN, a WiMAX network, a cellular network, etc. The HPLMN server(s) may include a HSS, an AAA server, a remote server, etc. The SRD 202 may provide the AP 204 with service request information, IP connectivity protocol information, PDN information, and/or PDN gateway information. The SRD 202 may communicate with the HPLMN server(s) 208 via the AP 204 and/or a serving gateway 210 to setup connectivity and mobility tunnel(s), for communication between the SRD 202 and the a PDN gateway 212. The tunnel(s) may include a connectivity tunnel and/or a mobility tunnel.

The SRD 202 may include an antenna 220, an SR analog front-end module 222, a SR transmit module 224, a SR receive module 226, and a SR control module 228. The SR analog front-end module 222 may transmit signals generated by the SR transmit module 224 via the antenna 220 and may output signals received from the antenna 220 to the SR receive module 226. The SRD 202 may also include PDN description generator 230 for the generation of APNs and PDN descriptors, as described herein.

The AP 204 may include an antenna 240, an AP analog front-end module 242, an AP transmit module 244, an AP receive module 246, and an AP control module 248. The AP analog front-end module 242 may transmit signals generated by the AP transmit module 244 via the antenna 240 and may output signals received from the antenna 240 to the AP receive module 246.

The MME 206 may include an antenna 250, a MME analog front-end module 252, a MME transmit module 254, a MME receive module 256, and a MME control module 258. The MME analog front-end module 254 may transmit signals generated by the MME transmit module 254 via the antenna 250 and may output signals received from the antenna 250 to the MME receive module 256.

The HPLMN server(s) 208 may include an antenna 260, a HPLMN server(s) analog front-end module 262, a HPLMN server(s) transmit module 264, a HPLMN server(s) receive module 266, and a HPLMN server(s) control module 268. The HPLMN server(s) analog front-end module 262 may transmit signals generated by the HPLMN server(s) transmit module 264 via the antenna 260 and may output signals received from the antenna 260 to the HPLMN server(s) receive module 266. The HPLMN server(s) 208 may include PDN records 270 and SRD records 272.

The serving gateway 210 an antenna 280, a serving gateway analog front-end module 282, a serving gateway transmit module 284, a serving gateway receive module 286, and a HPLMN server(s) control module 288. The serving gateway analog front-end module 282 may transmit signals generated by the serving gateway transmit module 284 via the antenna 280 and may output signals received from the antenna 280 to the serving gateway receive module 286.

The PDN gateway 212 an antenna 290, a PDN gateway analog front-end module 292, a PDN gateway transmit module 294, a PDN gateway receive module 296, and a PDN gateway control module 297. The PDN gateway analog front-end module 292 may transmit signals generated by the PDN gateway transmit module 294 via the antenna 290 and may output signals received from the antenna 290 to the PDN gateway receive module 296. The PDN gateway 212 may be in communication with a PDN 298 that provides operator IP services 299.

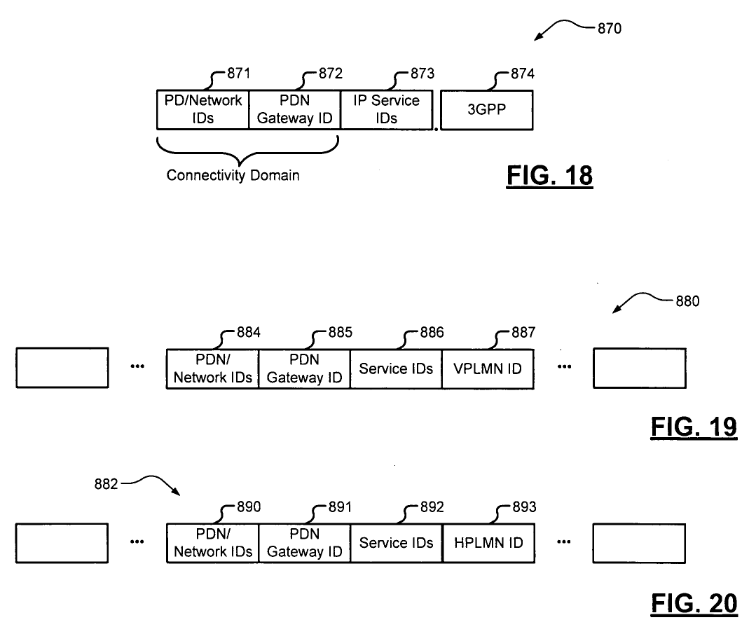

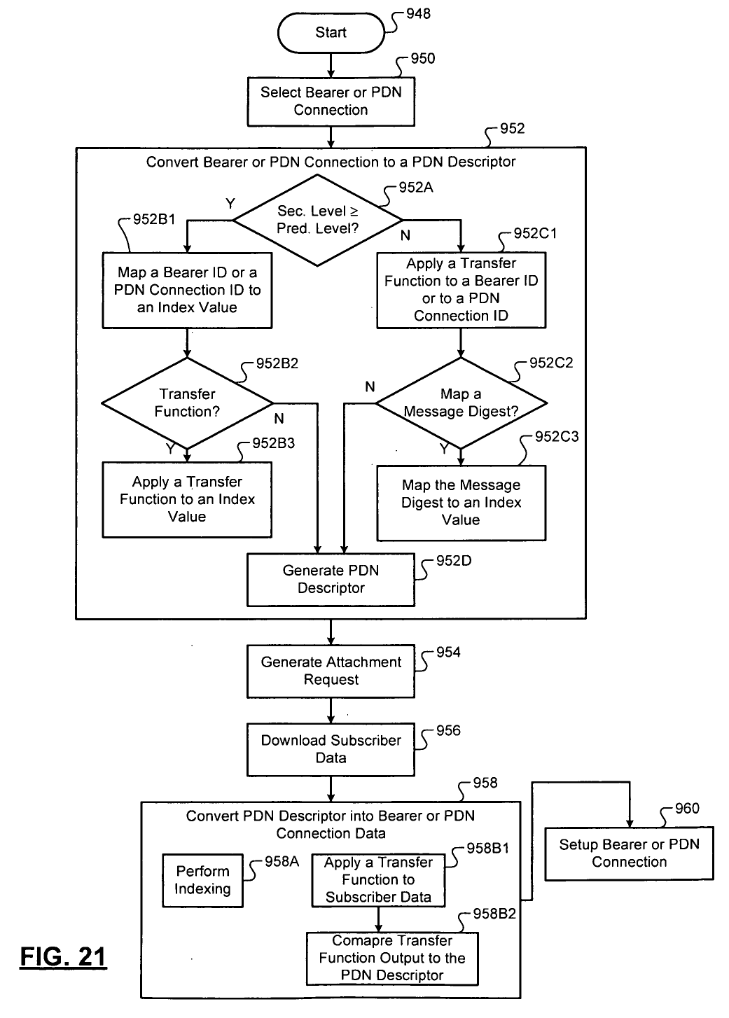

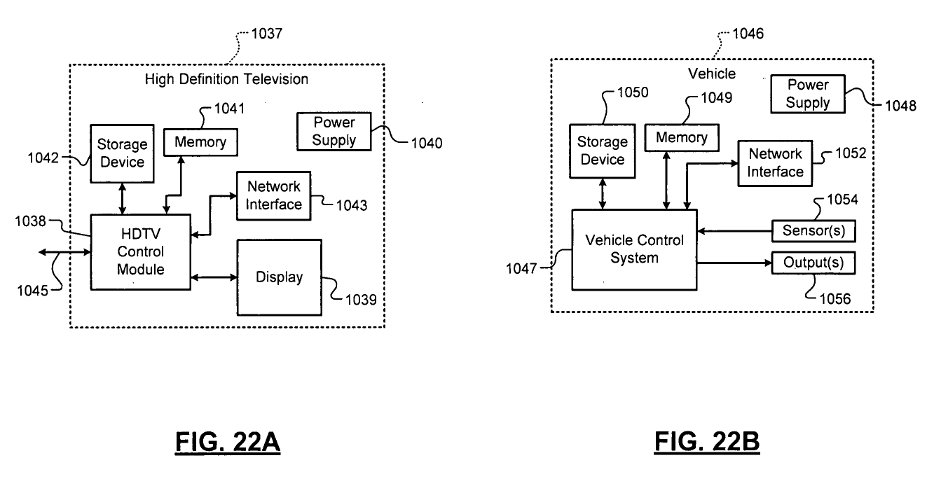

The SRD 202 initiates an information exchange between the SRD 202 and the AP 204. The SR control module 228 may generate an access point name (APN), with a PDN descriptor, or other PDN or IP service indication, such as a fully qualified domain name (FQDN). The PDN descriptor may identify a packet data network (PDN), a PDN gateway, and IP service(s). An example of an APN is shown in FIG. 18 and example FQDNs are shown in FIGS. 19 and 20.

The APN may be generated by the PDN description generator 230. In one embodiment, the SRD 202 performs an attachment request and receives an indication of a selected connectivity protocol, mobility protocol, and IP service(s) and a selected PDN gateway through which requested services may be provided.

An SRD when attaching to a network system may use a default IP access service to enable IP connectivity. The SRD does not need to perform any explicit activation procedure to transfer data. For example and with respect to a GPRS, a packet data protocol context activation procedure is performed along with a GPRS attachment procedure.

When a SRD attaches to a network system, the SRD may instead of or in addition to using a default IP access service may provide and receive mobility protocol and PDN gateway information. This information may be provided early on in an attachment process. When a SRD is incapable of providing connectivity domain and IP service information, a connectivity domain and IP services may be selected by a network and used as a default.

The embodiments disclosed herein enable a mobility mode. The mobility mode refers to the ability of a SRD to roam between local and/or global networks. The mobility mode is setup based on SRD and network system mobility capabilities, mobility preferences, and SRD profiles and may refer to selected mobility protocols for IP connectivity and handoff, as well as a selected PDN gateway. The decision to operate in a mobility mode may be made by a home network, such as a HPLMN, and may change based on updated SRD parameters and/or network system parameters.

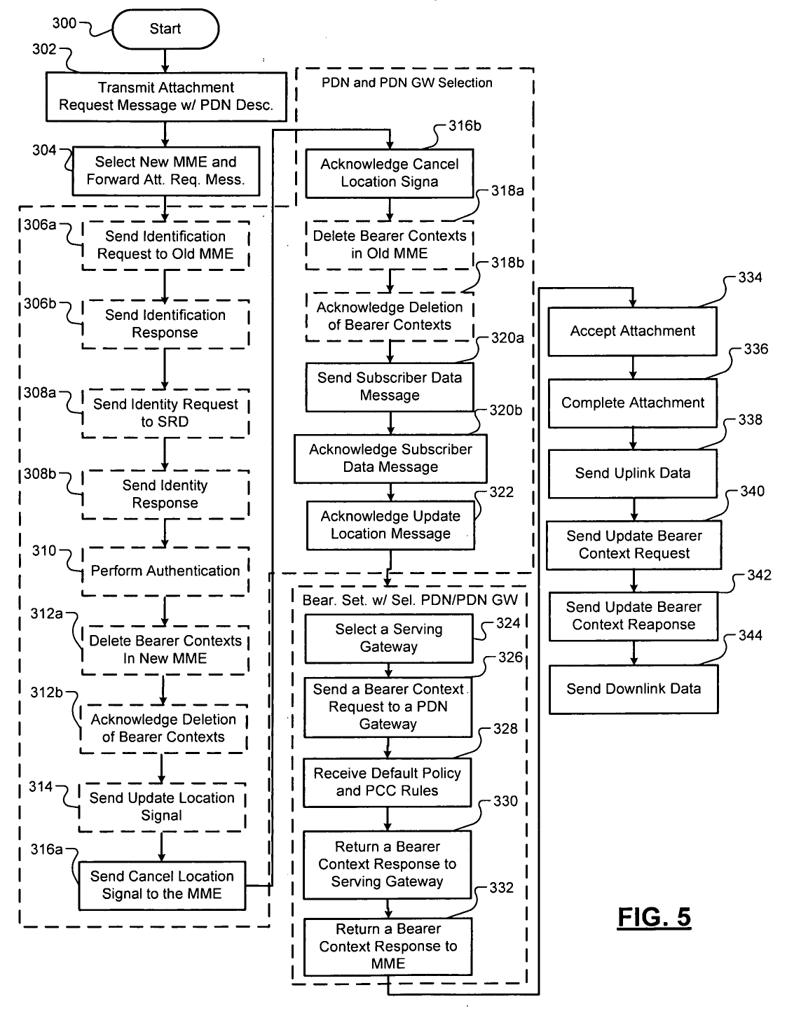

The following methods of FIGS. 5-6, 9-12 may be performed using the network system 200.

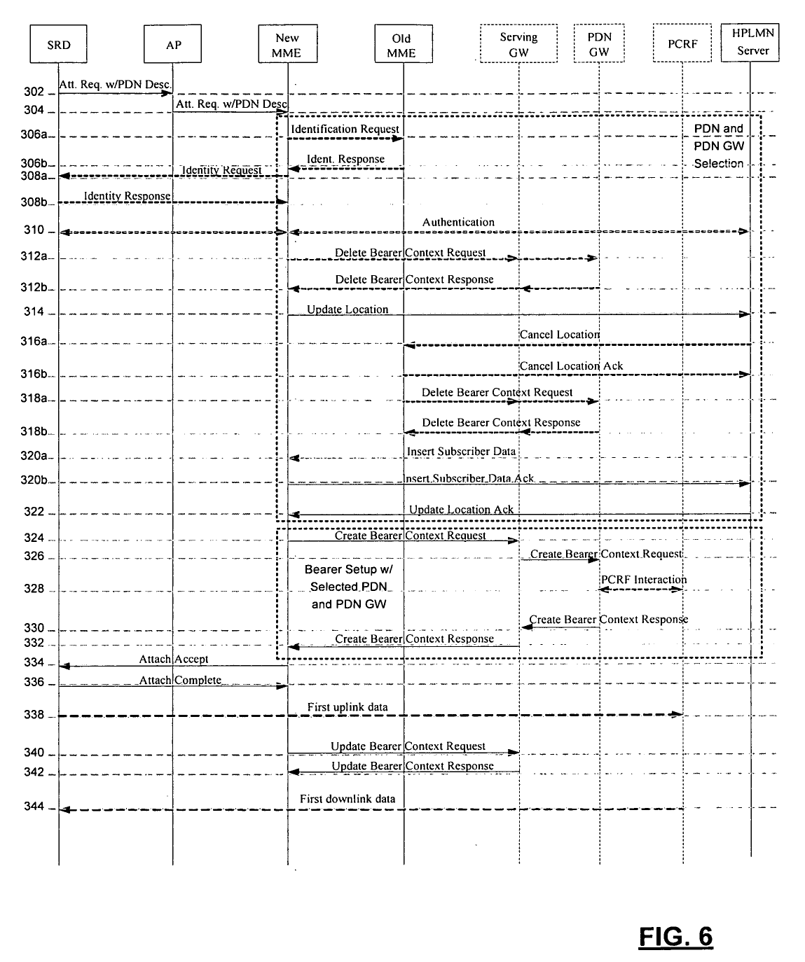

Referring now to FIGS. 5 and 6, a flow diagram and a message flow diagram illustrating a method of managing connectivity for wireless access in a network that supports long term evolution is shown. The method may apply to GPRS with long term evolution (LTE) access. The message flow diagram applies to both roaming and non-roaming architectures, such as that provided in FIGS. 2 and 3. The method may begin at step 300.

In step 302, the SRD initiates an attach procedure by transmission of an attach request message to an AP, such as an evolved node B base station (eNodeB). The attachment request message may include a PDN descriptor that includes a PDN, a PDN gateway ID and/or IP service IDs, which may be preferred by the SRD. The PDN descriptor may be used by a network to setup a bearer corresponding to the SRD. The network may setup a tunnel corresponding to the requested PDN, PDN gateway, and IP services or a different tunnel. A different tunnel may be setup based on network capabilities, subscriber information, authentication and authorization of the SRD, etc. The PDN descriptor may be a predefined string that a network is able to interpret, an APN, a FQDN, etc. A network may have a predefined mapping between PDN descriptors and PDNs and PDN gateways.

The attachment request message may also include an international mobile subscriber identity (IMSI) or a S-temporary mobile subscriber identity (S-TMSI) and an old target attachment identifier (TAI) of a selected network. In step 304, the AP selects a new MME and forwards the attach request message together with an indication of a cell global identity of the SRD to the new MME. The term may old refers to a previous or current network device and corresponding identifiers. The term new may refer to a current, subsequent, or updated network device and corresponding identifiers.

In the following steps 306a-322, the MME, the serving gateway, and/or an HPLMN server, such as the HSS, selects a PDN, a PDN gateway and IP services for the SRD. The selections are based on the PDN, PDN gateway and IP service preferences provided by the SRD.

In step 306a, when the SRD identifies itself with a S-TMSI and the MME has changed since detach of the SRD, the new MME may send an identification request to an old MME to request an IMSI. The identification request may include a S-TMSI and an old TAI. In step 306b, the old MME may respond with an identification response. The identification response may include an IMSI and authentication quintets. When the SRD is not known by the old MME, the old MME may respond with an appropriate error signal.

In step 308a, when the SRD is unknown in both the old and new MME, the MME sends an identity request to the SRD to request the IMSI. In step 308b, the SRD responds with an identity response including the IMSI.

In step 310, when no SRD context for the SRD exists in the network, authentication is performed. The SRD 12 when accessing the PDN gateway 16 generates an access authentication signal, which is transmitted to the MME 22 via the AP. A SRD context or bearer context may include information required to establish access network bearers in a cellular network for an ongoing Internet session of the SRD. An SRD context may include a set of addresses allocated to the SRD. The addresses may include a PDN gateway address, a PDN address, a serving gateway address, etc.

The MME 22 generates an AAA request signal that is transmitted to the HSS 26. As part of an authentication procedure the HSS 26 authenticates the SRD 12. During step 58 or one of steps 60-70, the HSS, the serving GW, and/or the MME selects the PDN gateway and the PDN.

In step 312a, when there are active bearer contexts in the new MME for the SRD (i.e. the SRD re-attaches to the same MME without having properly detached before), the new MME deletes these bearer contexts by sending a delete bearer context request message to the PDN gateway involved. In step 312b, the PDN gateway acknowledges with a delete bearer context response message.

In step 314, when the MME has changed since the last detach, or when it is a first attachment for the SRD, the MME sends an update location signal to the HSS. The update location signal may include an MME identity and the IMSI.

In step 316a, the HSS sends a cancel location signal to the old MME. The cancel location signal may include the IMSI and a cancellation type. The cancellation type may indicate to update a procedure. In step 316b, the old MME acknowledges with a cancel location acknowledgement signal, which may include the IMSI, and removes the mobility management and bearer contexts.

In step 318a, when there are active bearer contexts in the old MME for the SRD, the old MME deletes these bearer contexts by sending a delete bearer context request message to the SAE GW involved. In step 318b, the SAE GW returns a delete bearer context response message to the MME.

In step 320a, the HSS sends a subscriber data message to the new MME. The new MME validates the SRD's presence. When the SRD is not allowed to attach, such as due to regional subscription restrictions, access restrictions, or subscription checking fails, the MME rejects the attach request. The MME may generate an attachment rejection signal indicating reasons for not accepting attachment. When all checks are successful then the MME constructs a context for the SRD. The MME may return an insert subscriber data acknowledgement message to the HSS, identified by step 320b. The insert subscriber data acknowledgement message may include the reasons for not accepting attachment of the SRD.

In step 322, the HSS acknowledges the update location message by sending an update location acknowledgement to the MME. When the update location is rejected by the HSS, the MME rejects the attach request from the SRD and may provide reasons for the rejection in a response signal.

In the following steps 324-332, a default bearer is setup based on the selected PDN and PDN gateway. The default bearer may be setup by the PDN gateway. In step 324, the MME selects a serving SAE GW and sends a create SAE bearer request message to the selected serving SAE GW.

In step 326, the serving gateway creates a new entry in a bearer table and sends a create bearer context request message to the PDN gateway. The create bearer context request message may include a serving gateway address for the user plane, a serving gateway tunnel endpoint identifier (TEID) of the user plane, and a serving gateway TEID of the control plane.

The PDN gateway may assign the PDN address to the SRD or leave the PDN address unassigned. In some cases (e.g., a non-integrated device, such as laptop), the SRD PDN address may need to be assigned after the completion of the attach procedure (e.g., via DHCP).

In step 328, the PDN gateway may interact with the PCRF to get default policy and charging control (PCC) rules for the SRD. In step 330, the PDN gateway returns a create bearer context response message to the serving gateway. The bearer context response message may include a PDN gateway address for the user plane, a PDN gateway TEID of the user plane, a PDN gateway TEID of the control plane, and a PDN address.

In step 332, the serving gateway returns a create bearer context response message to the MME. The create bearer context response message may include a PDN address, a serving gateway address for the user plane, a serving gateway TEID for the user plane, and a serving gateway context ID.

In step 334, the MME sends an attach accept message to the eNodeB. The attach accept message may be referred to as an attachment reply signal that indicates attachment acceptance based on the PDN descriptor. The attach accept message may include a S-temporary mobile subscriber identity (S-TMSI), a PDN address, and a terminal adaptor (TA) list. S-TMSI is included if the MME allocates a new S-TMSI. This message is contained in an S1_MME control message initial context setup request. This S1 control message also includes the security context for the SRD and quality of service (QoS) information needed to set up the radio bearer, as well as the TEID at the serving gateway used for user plane and the address of the serving gateway for user plane. The PDN address assigned to the SRD is included in this message. The AP sends radio bearer establishment request to the SRD and the attach accept message including the S-TMSI, a PDN address, and a TA List is sent to the SRD.

In step 336, the SRD sends the radio bearer establishment response (FFS) to the AP. In this message, the attach complete message is included. The AP forwards the attach complete message to the MME. On the S1_MME reference point, this message is contained in an S1_MME control message initial context setup complete. This S1 control message also includes the TEID of the AP and the address of the AP used for downlink traffic on a S1_U reference point.

In step 338, the SRD sends uplink packets to the AP, which are tunneled to the serving gateway and PDN gateway. In step 340, the MME sends an update bearer context request message to the serving gateway. The update bearer context request message may include an AP address and an AP TEID.

In step 342, the serving gateway acknowledges by sending an update bearer context response to the MME. In step 344, the PCRF and/or the PDN gateway may send buffered downlink packets to the SRD. The SRD 12 receives services from the PDN via the PDN gateway 16.

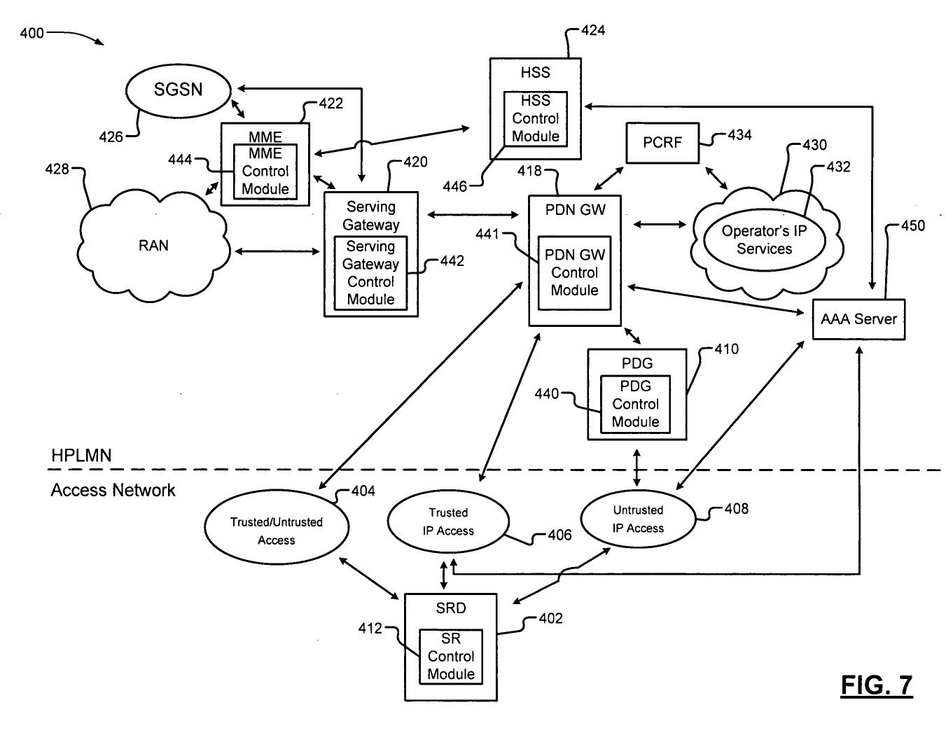

Referring now to FIG. 7, a functional block diagram of an exemplary network system 400 for trusted and untrusted non-roaming access is shown. The network system 400 applies to host-based and network-based mobility and includes an access network (AN), such as a non-3GPP™ network, and a HPLMN. A SRD 402 may access the HPLMN from the AN using trusted/untrusted access 404, such as trusted/untrusted non-3GPP™ IP access or 3GPP™ access, or using trusted IP access 406, such as trusted non-3GPP™ IP access. A SRD 402 may also access the HPLMN from the AN using untrusted IP access 408, such as untrusted non-3GPP™ IP access. The untrusted IP access 408 is provided through a packet data gateway (PDG) 410.

The network system 400 includes the SRD 402 with a SR control module 412. The SRD 402 may access the HPLMN using procedures associated with either the host-based access or the network-based access. The SRD 402 may be a trusted or untrusted network device.

The HPLMN includes the PDG 410, a PDN gateway 418, a serving gateway 420, a MME 422 and a HSS 424. The SRD 402 may communicate with the PDG 410 or the PDN gateway 418. The PDN gateway 418 is in communication with the serving gateway 420, which is in turn in communication with the MME 422. The MME is in communication with the HSS 424, a SGSN 426, and a RAN 428. The PDN gateway 418 is in communication with a PDN 430 that provides IP services 432 and a PCRF entity 434. The PDG 410, the PDN gateway 418, the serving gateway 420, the MME 422, and the HSS 424 respectively have a PDG control module 440, a PDN control module 441, a serving gateway control module 442, a MME control module 444 and a HSS control module 446.

The MME 422 performs SRD tracking and security functions. The MME 442 and/or the HSS 424 may perform packet data network (PDN) gateway and/or serving gateway selection. The SGSN 426 may perform MME selection, PDN gateway selection, and/or serving gateway selection. The PCRF 434 may be used to terminate reference points between network devices, such as references points associated with PDN gateways, PCRF devices, devices of a packet data network, etc.

The HPLMN may also include an AAA server 450 that provides authentication, authorization and accounting information and subscriber profile information to the PDN gateway 441 and/or the HSS 424. The stated information may be provided to the AN, for example, when trusted network-based IP access is performed. This information may be obtained from the HSS 424. For example, the AAA server 450 may authenticate the subscriber with the HSS 424 after an invoked tunnel establishment request by the SRD 402.

The HSS 424 may have authentication and subscription data and quality of service profiles for the subscriber. The HSS 424 may also store an IP address of the AAA server 450 to which the SRD 402 is registered. The HSS 424 may perform PDN gateway selection.

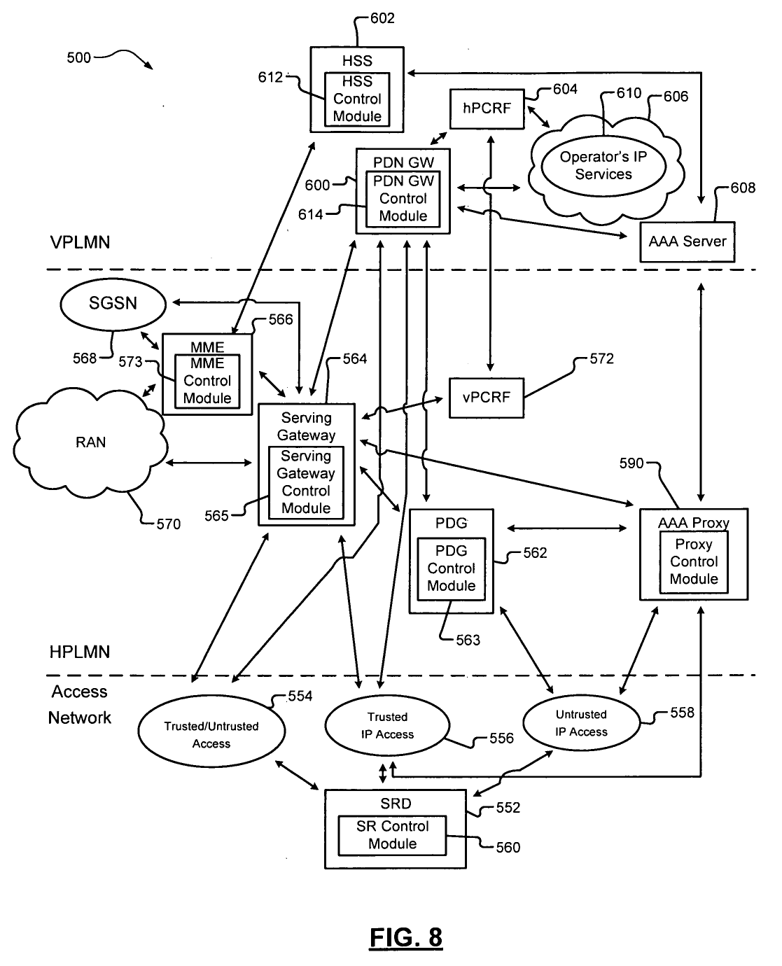

Referring now to FIG. 8, a functional block diagram of an exemplary network system 500 for trusted and untrusted roaming access is shown. The network system 500 applies to host-based and network-based mobility. The network system 500 includes an AN, a VPLMN, and a HPLMN. A SRD 552 may access the HPLMN from the AN via the VPLMN.

The SRD 552 may access the VPLMN from the AN using trusted/untrusted access 554, such as trusted/untrusted non-3GPP™ IP access or 3GPP™ access, or using trusted IP access 556, such as trusted non-3GPP™ IP access. A SRD 552 may also access the VPLMN from the AN using untrusted IP access 558, such as untrusted non-3GPP™ IP access. The untrusted IP access 408 is provided through a packet data gateway (PDG) 560.

The network system 500 includes the SRD 552 with a SR control module 560. The SRD 552 may access the VPLMN using procedures associated with either the host-based access or the network-based access. The SRD 552 may be a trusted or untrusted network device. Untrusted IP access to the HPLMN is provided via a PDG 562 of the VPLMN.

The VPLMN includes the PDG 562 and a serving gateway 564. The PDG 562 and the serving gateway 564 respectively include a PDG control module 563 and a serving gateway control module 565. The SRD 552 may communicate with the PDG 562 directly or via the serving gateway 564. The serving gateway 564 is in communication with a MME 566, a SGSN 568, a RAN 570, and a visiting PCRF (vPCRF) device 572. The MME includes a MME control module 573.

The MME 566 performs SRD tracking and security functions. The MME 566 may perform PDN gateway and/or serving gateway selection. The SGSN 568 may perform MME selection, PDN gateway selection, and/or serving gateway selection. The vPCRF device 572 may be used to terminate reference points between network devices, such as references points associated with PDN gateways, PCRF devices, devices of a packet data network, etc.

The VPLMN may also includes a AAA proxy server 580 that provides authentication, authorization and accounting information and subscriber profile information to the serving gateway 564, the PDG 562 and/or the AN. The stated information may be provided to the AN, for example, when trusted network-based IP access is performed.

The HPLMN includes a PDN gateway 600 that is in communication with a HSS 602, a home policy and changing rules function (hPCRF) device 604, a PDN 606 and an AAA server 608. The PDN 606 provides operator IP services 610. The HSS 602 and the PDN gateway 600 respectively include a HSS control module 612 and a PDN gateway control module 614.

The HSS 602 may have authentication and subscription data required for a subscriber, such as a subscriber associated with the SRD 552, to access a AN interworking service. The HSS 602 may have quality of service profiles, authentication, and subscription data for the subscriber. The HSS 602 may also store an IP address of the MA server 608 to which the SRD 552 is registered. The HSS 602 may perform PDN gateway selection. The hPCRF device 604 may be used to terminate reference points between network devices, such as reference points associated with the serving gateway 564, the vPCRF 572, and the hPCRF 604.

The AAA server 608 provides authentication, authorization and accounting information and subscriber profile information. This information may be obtained from the HSS 602. For example, the AAA server 608 may authenticate the subscriber with the HSS 602 after an invoked tunnel establishment request by the SRD 552.

The network system 500, as well as other systems described herein may comply with 3GPP™ TS 23.401 (General Packet Radio Service Enhancements for Evolved Universal Terrestrial Radio Access Network E-UTRAN Access), 3GPP™ TS 23.402 (Architecture Enhancements for Non-3GPP™ Accesses), and 3GPP™ TS 23.203 (Policy and Charging Control Architecture), which are incorporated herein by reference in their entirety.

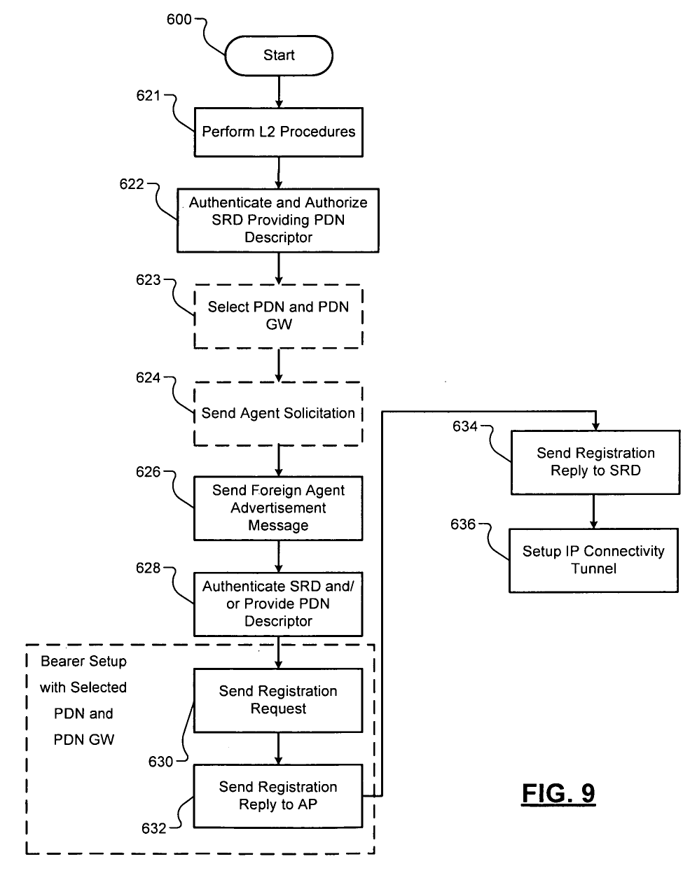

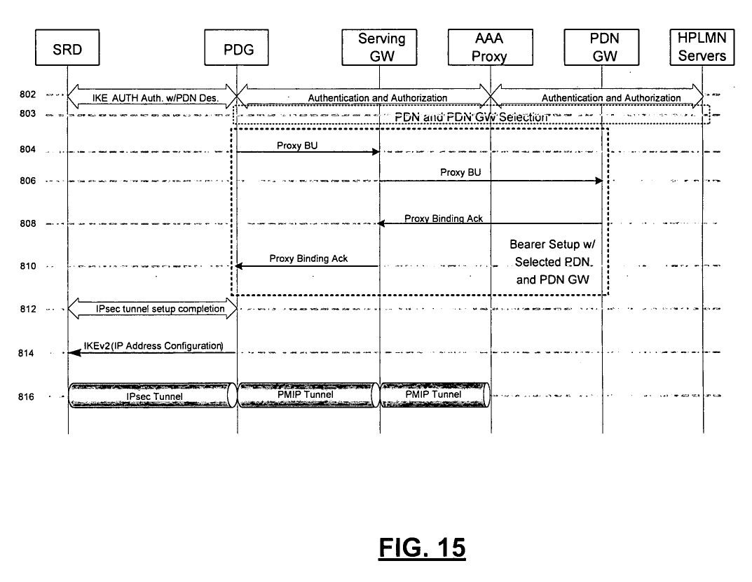

The methods of the following FIGS. 9-12 and 14-17 may be applied to the network systems of FIGS. 7 and 8.

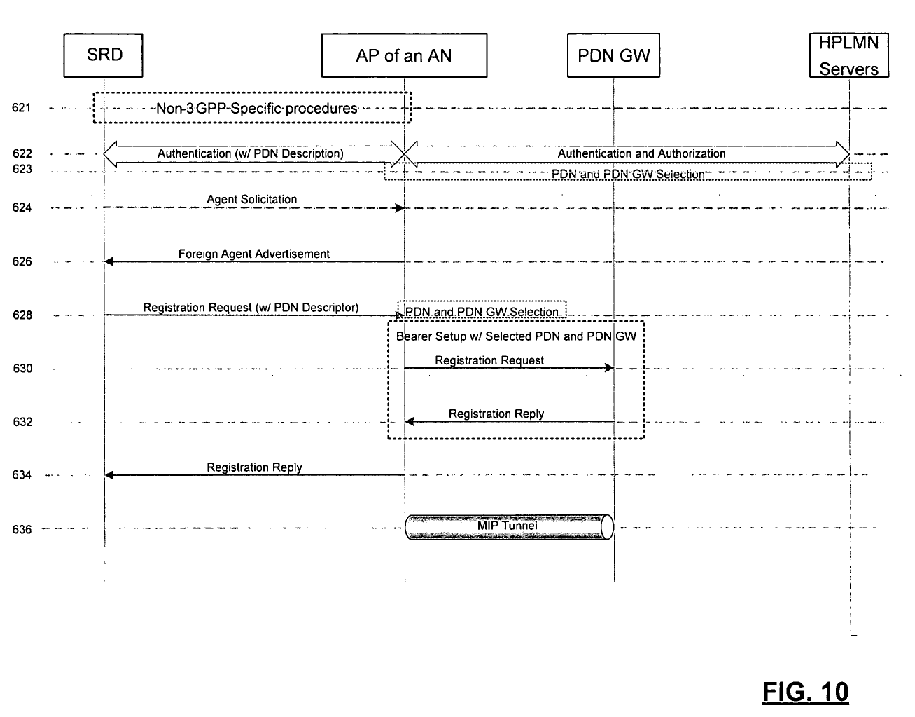

Referring now to FIGS. 9 and 10, a flow diagram and a message flow diagram illustrating a method of managing connectivity for wireless access in a network for trusted access using a host-based mobility protocol are shown. The method may be applied to non-3GPP™ access and may begin at step 600.

In step 621, the initial non-3GPP™ access specific L2 procedures may be performed. Layer 2 procedures refer to procedures that may be performed by a data link layer of an open systems interconnection basic reference model (OSI) model.

In step 622, a non-3GPP™ access specific authentication procedure is performed. The authentication procedure is performed between an SRD and an access point (AP) of an AN, such as for trusted non-3GPP™ IP access. The event that triggers authentication and authorization between non-3GPP™ IP access and HPLMN servers, such as an AAA and/or a HSS depends on the specific type of non-3GPP™ access system.

During step 622 or step 628 the SRD provides an APN and/or PDN descriptor to the AN. In step 622, an authentication request message may be generated that includes a PDN descriptor with a PDN, a PDN gateway ID and/or IP service IDs, which may be preferred by the SRD. The PDN descriptor may be used by a network to setup a bearer corresponding to the SRD.

Also, during step 622, step 623 and/or step 628 a PDN and a PDN gateway are selected. IP services may also be selected. This selection may be performed in step 622, 628, or in some other step, such as by one of the HPLMN servers or by an MME, a serving gateway, or other network device. In step 624, the SRD may send an agent solicitation (AS) message.

In step 626, a FA in the AN sends a foreign agent advertisement (FAA) message to the SRD. The FAA message may include a care-of address (CoA) of the foreign agent function in the FA.

In step 628, the SRD sends a registration request (RRQ) message to the FA. The RRQ message may include a PDN descriptor. Reverse tunneling is requested. This ensures that IP traffic passes through a PDN GW. The RRQ message includes a network access identifier (NAI)-extension. The PDN, the PDN gateway and the IP services may be selected if not selected in a previous step.

In the following steps 630-632, a bearer may be setup with the selected PDN and PDN gateway. In step 630, the FA processes the message according to the registration request message and forwards a corresponding RRQ message to the PDN GW. In step 632, the PDN GW allocates an IP address for the SRD and sends a registration reply (RRP) to the FA, including the IP address allocated for the SRD.

In step 634, the FA processes the RRP according to and sends a corresponding RRP message to the SRD. The RRP message may be referred to as an attachment reply signal and indicate attachment completion based on the PDN descriptor. In step 636, setup of IP connectivity between the SRD and the PDN GW is completed. A MIP tunnel is established between the FA and the PDN GW.

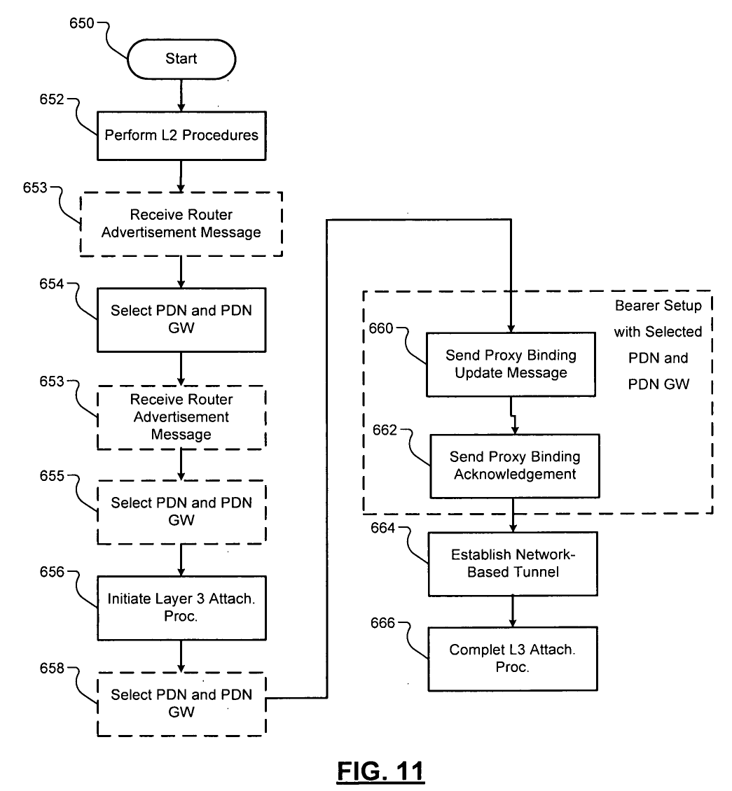

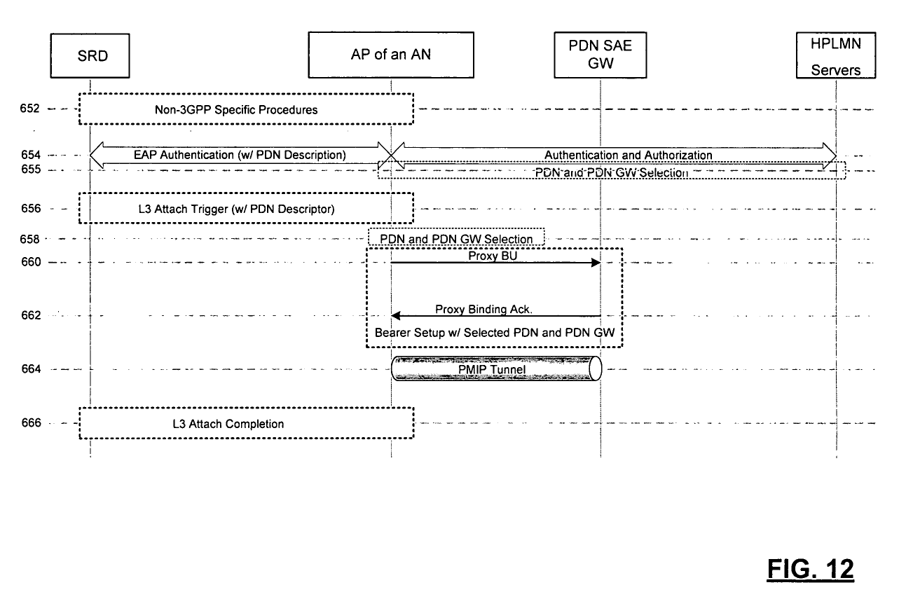

Referring now to FIGS. 11 and 12, a flow diagram and a message flow diagram illustrating a method of managing connectivity for wireless access in a network for trusted access using a network-based mobility protocol are shown. This method may apply to non-3GPP™ access and may begin at step 650. In step 652, initial non-3GPP™ access specific layer 2 procedures may be performed. In step 653, the SRD may determine that the local access network requires stateful IP address configuration. The SRD may receive a router advertisement message indicating this.

In step 654, the SRD generates and sends a DHCP request message to request an IP address and also to indicate connectivity domain and IP services preferences. The DHCP request message may include a PDN descriptor as described herein. Connectivity domain and IP services indication may be provided in step 656 instead of step 654. An EAP authentication procedure may be initiated and performed involving the SRD, the access network, and an AAA server. Unlike in the roaming case where multiple AAA proxies may be involved, an AAA proxy may not be involved.

During step 654, 655 and/or step 658, a PDN and a PDN gateway are selected. IP services may also be selected. This selection may be performed in step 654, 658, or in some other step, such as by one of the HPLMN servers or by an MME, serving gateway, or other network device. When no indication of the connectivity domain and IP services, a default connectivity domain and IP services may be selected.

In step 656, after successful authentication and authorization, a layer 3 attachment procedure is initiated. A layer 3 procedure may refer to a procedure that is performed by a network layer of an OSI model. The layer 3 attachment procedure may be based off of DHCP or Neighbor Discovery protocols and/or stateless IP address configurations.

CMIPv6 nodes on the same link use a Neighbor Discovery protocol to discover each other's presence, to determine each other's link-layer addresses, to find routers, and to maintain contact information about the paths to active neighbors. Nodes (hosts and routers) use the Neighbor Discovery protocol to determine the link-layer addresses for neighbors known to reside on attached links and to quickly purge cached values that become invalid. Hosts also use the Neighbor Discovery protocol to find neighboring routers that are willing to forward packets on their behalf. Finally, nodes use the Neighbor Discovery protocol to actively keep track of which neighbors are reachable and which are not, and to detect changed link-layer addresses. When a router or the path to a router fails, a host actively searches for functioning alternates. For further details on the Neighboring Discovery protocol see RFC 4861, which is incorporated herein by reference in its entirety.

In step 658, PDN, PDN gateway and IP service selection may be performed when not performed in a previous step. In step 660, the access network or a mobility access gateway (MAG) may send a proxy binding update message to the selected PDN gateway. The MAG may be part of the trusted access network. In step 662, the PDN gateway processes the proxy binding update and generates a binding cache entry for the SRD. The PDN gateway allocates an IP address(es) (e.g. remote IP address(es)) for the SRD. The PDN gateway then sends a proxy binding acknowledgement to the MAG including the IP address(es) allocated to the SRD. When the SRD requests both an IPv4 and an IPv6 address, multiple IP addresses are allocated. When the SRD requests an IPv4 address or an IPv6 address, then a single IP address may be allocated.

In step 664, the network establishes a network-based mobility protocol tunnel, such as a PMIP tunnel. For example, a PMIPv6 tunnel may be setup between the access network and the selected PDN gateway. In step 666, the layer 3 attachment procedure is completed. The SRD may receive an attachment reply signal that indicates attachment completion based on the PDN descriptor. IP connectivity between the SRD and the PDN gateway is set for uplink and downlink communication.

When a SRD supports a MIPv4 host-based mobility protocol for IP connectivity and/or handoff, a MIPv4 FA mode may be enabled. The SRD may generate an agent solicitation message to indicate the SRD mobility protocol preferences. The agent solicitation message is provided to an access network. When the access network supports the MIPv4 FA mode, the access network responds with a MIPv4 agent advertisement message. The SRD operates in the MIPv4 FA mode based on reception and/or content of the agent solicitation message.

When a SRD supports a MIPv6 host-based mobility protocol, the SRD may provide an indication of mobility protocol preferences. The SRD may establish full local connectivity through the access network without indicating mobility protocol preferences of the SRD. The SRD may establish connectivity by indicating mobility protocol preferences to the access network.

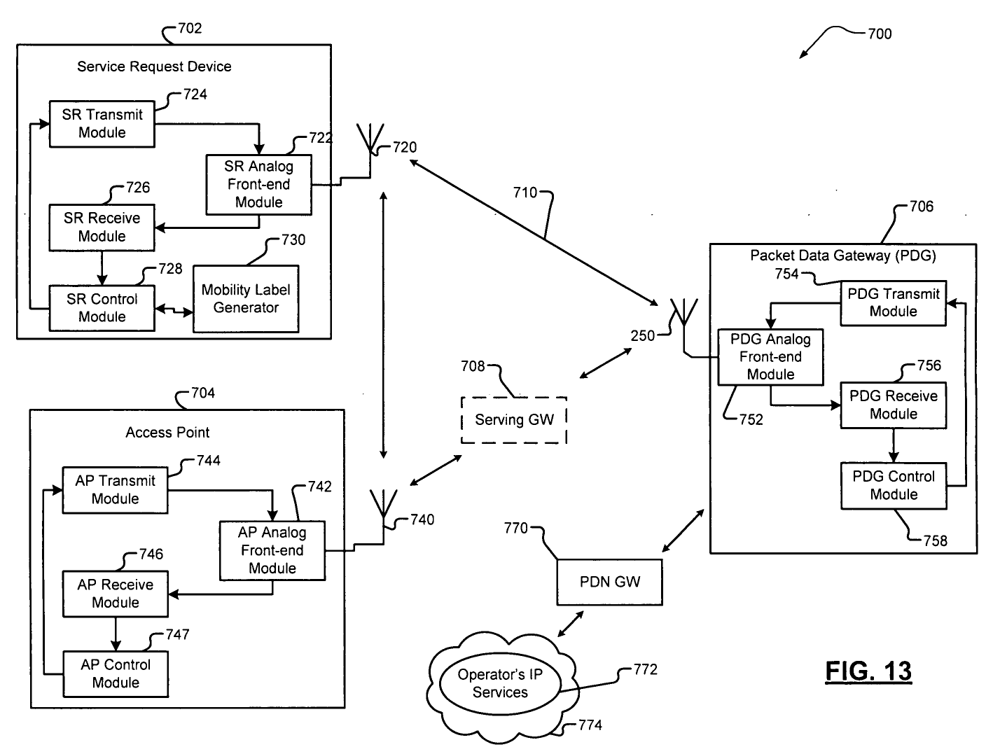

Referring now to FIG. 13, a functional block diagram of another exemplary network system 700 is shown. The network system 700 includes a SRD 702, an AP 704 and a PDG 706. The SRD 702 communicates with the AP 704 to select the PDG 706. The SRD 702 may communicate with the PDG 706 via the AP 704 and a wireless access gateway (WAG) 708 to setup connectivity and mobility tunnel(s), designated by line 710, for communication between the SRD 702 and the PDG 706. The tunnel(s) 710 may include a connectivity tunnel and/or a mobility tunnel.

The SRD 702 may include an antenna 720, an SR analog front-end module 722, a SR transmit module 724, a SR receive module 726, and a SR control module 728. The SR analog front-end module 722 may transmit signals generated by the SR transmit module 724 via the antenna 720 and may output signals received from the antenna 720 to the SR receive module 726. The SRD 702 may include a PDN description generator 730 for the generation of a PDN descriptor.

The AP 704 may include an antenna 740, an AP analog front-end module 742, an AP transmit module 744, an AP receive module 746, and an AP control module 747. The AP analog front-end module 742 may transmit signals generated by the AP transmit module 744 via the antenna 740 and may output signals received from the antenna 740 to the AP receive module 746. The AP 704 may also include an AP local DNS server 748 with DNS records 749. The SR control module 728 may access or request information in the DNS records 749 when performing a DNS query.

The PDG 706 may include an antenna 750, a PDG analog front-end module 752, a PDG transmit module 754, a PDG receive module 756, and a PDG control module 758. The PDG analog front-end module 706 may transmit signals generated by the PDG transmit module 754 via the antenna 750 and may output signals received from the antenna 750 to the PDG receive module 756. The PDG 706 may also include a remote DNS server 760 with DNS records 762. The SR control module 728 may access or request information in the DNS records 762 when performing a DNS query.

The SRD 702 initiates an information exchange between the SRD 702 and the AP 704. The SR control module 728 may generate a descriptor that includes an APN, a FQDN, or other PDN and IP service indication. The APN may identify a PDN that the SRD 702 selects as the local network of the AP 704. The SRD 702 may also generate a FQDN to request services and to identify a local and/or remote network that may include the local network of the AP 704. The FQDN may include a PDN descriptor identifying the PDN and PDN gateway preferred by the SRD 702.

When the connectivity protocol is host-based, the SR control module 728 may set up the connectivity tunnel between the SRD 702 and the PDG 706 and/or a serving gateway of a remote network using a host-based protocol (e.g., CMIP). The PDG 706 may respectively function as a FA or as an access router when the CMIP is MIPv4 or MIPv6.

When the connectivity protocol is network-based, the PDG control module 758 may set up the connectivity tunnel between the SRD 702 and the PDG 706 and/or between the PDG 706 and a serving gateway using a network-based protocol (e.g., PMIP). The PDG 706 may function as a PMA. The SRD 702 may connect to the PDG 706 via the connectivity tunnel set up between the SRD 702 and the PDG 706.

The SRD 702 may communicate with a remote network via the mobility tunnel when the SRD 702 roams from, for example, one local network to another (e.g., from a WLAN to a cellular network). The serving gateway 708 switches the mobility tunnel from one local network to another when the SRD 702 roams between local networks.

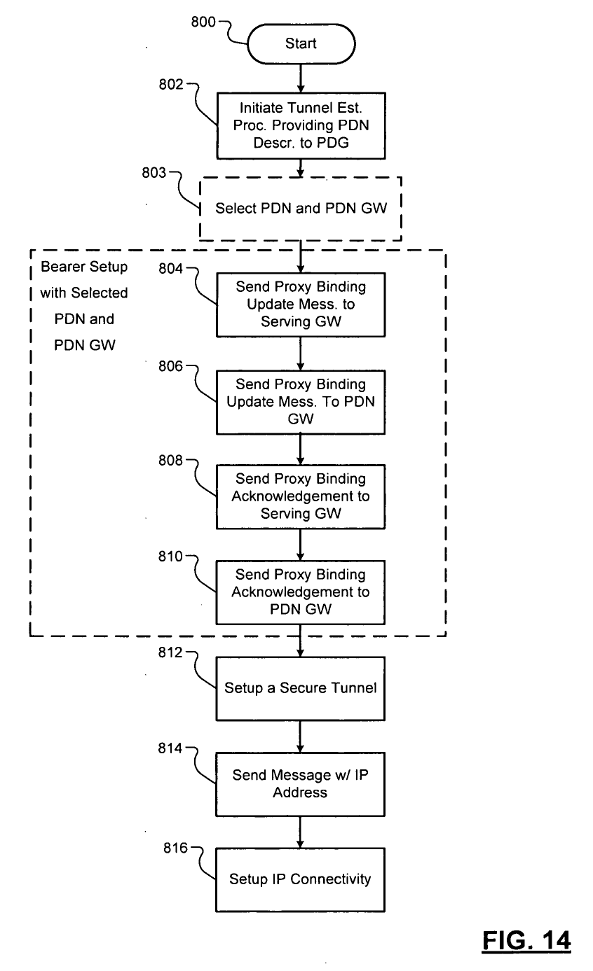

Unlike traditional methods of establishing connectivity, an identification of a PDN, a PDN gateway and IP services that are preferred by a SRD may be provided during a DNS query. FIGS. 14-17 illustrate exemplary methods, which include the stated identification. The stated identification may occur during W-APN resolution. W-APN resolution includes identification of services requested by a SRD and determination of which PDGs support those services. W-APN resolution occurs before tunnel establishment. Tunnel establishment refers to the establishment of connectivity and mobility tunnels between a SRD and/or a serving gateway and a selected PDG.

When performing a DNS query, the AP 704 and/or the PDG 706 may access a remote network 770 to obtain PDG information. The remote network 770 may include a remote DNS server 772 with DNS records 774.

Referring now to FIG. 14, a flow diagram and a message flow diagram illustrating a method of managing connectivity for wireless access in a network for untrusted access using a network-based mobility protocol are shown. The method may begin at step 800.

In step 802, a tunnel establishment procedure may be started by a SRD. The tunnel establishment procedure may be a IKEv2 tunnel establishment procedure that may be performed via an IKE authorization (IKE_AUTH) exchange. A PDG IP address to which the SRD needs to form an IPsec tunnel may be determined via DNS query or can be statically configured. For an example of a DNS query see 3GPP™ TS 23.234 “3GPP™ System to Wireless Local Area Network (WLAN) Interworking; System Description”, which is incorporated herein by reference in its entirety. The DNS query may include the generation of a FQDN using a W-APN network identifier and a VPLMN ID as an operator identifier. The FQDN may include a PDN descriptor, as described herein. After the SRD is authenticated, the SRD may also be authorized for access to an access point name (APN). For an example authorization procedure see 3GPP™ TS 33.234 “3G security; Wireless Local Area Network (WLAN) internetworking security”, which is incorporated herein by reference in its entirety.

Also, during step 802 or in step 803 a PDN and a PDN gateway are selected. IP services may also be selected. This selection may be performed in step 802 or in some other step, such as by one of the HPLMN servers or by an MME, a serving gateway, or other network device.

During one or more of the following steps 804-810, the a bearer is setup with the selected PDN and PDN gateway. In step 804, the PDG sends a proxy binding update message to the serving gateway. The proxy binding update message is secured.

In step 806, the serving gateway processes the proxy binding update message and creates a binding cache entry for the SRD. The serving gateway sends the proxy binding update message to the PDN gateway using the serving gateway's address as the proxy mobility agent (PMA) address. The proxy binding update message is secured. The binding cache entry on the serving gateway does not have the IP address information of the SRD. This information is added to the binding cache entry after step 808.

In step 808, the PDN gateway processes the proxy binding update and creates a binding cache entry for the SRD. The PDN gateway allocates an IP address for the SRD. The PDN gateway then sends a proxy binding acknowledgement to the serving gateway, including the IP address allocated for the SRD. Once the serving gateway processes the proxy binding acknowledgement, the serving gateway stores the IP address information of the SRD in the binding cache entry.

In step 810, after the proxy binding update/proxy binding acknowledgement is successful, a network-based tunnel (e.g., a PMIPv6 tunnel) is setup between the serving gateway and the PDN gateway. In step 812, the PDG continues with the IKE_AUTH exchange to setup a secure tunnel.

In step 814, the PDG sends a final message (e.g., final IKEv2 message) with the IP address in configuration payloads. The IP address sent in the configuration payload is the same address that the PDG received in the proxy binding acknowledgement message. The final message may be referred to as an attachment reply signal that indicates attachment completion based on the PDN descriptor.

In step 816, setup of IP connectivity from the SRD to the PDN gateway is completed and packets are permitted to be sent between the SRD and the PDN gateway. Packets may be sent from the SRD to the PDG in an uplink direction using the IPSec tunnel. The PDG then tunnels the packets to the serving gateway. The serving gateway then tunnels the packets to the PDN gateway. From the PDN gateway, IP based routing takes place. In the downlink direction, the packets for the SRD arrive at the PDN gateway. The PDN gateway tunnels the packet based on the binding cache entry to the serving gateway. The serving gateway tunnels the packets based on the binding cache entry to the PDG. The PDG then tunnels the packets to the SRD via the IPsec tunnel.

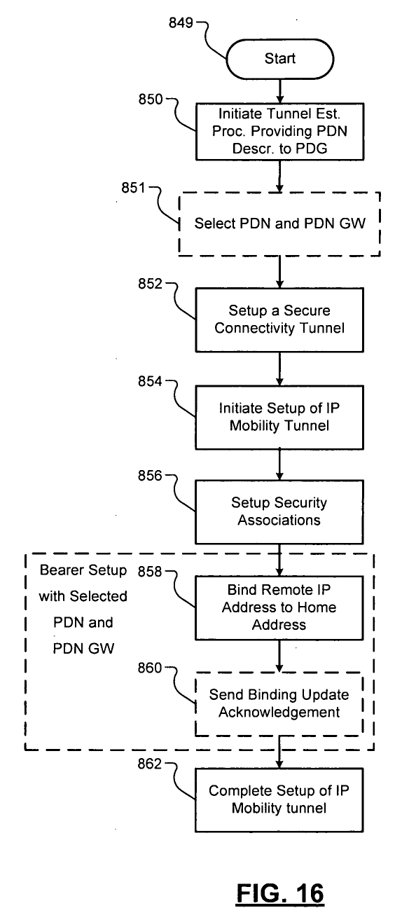

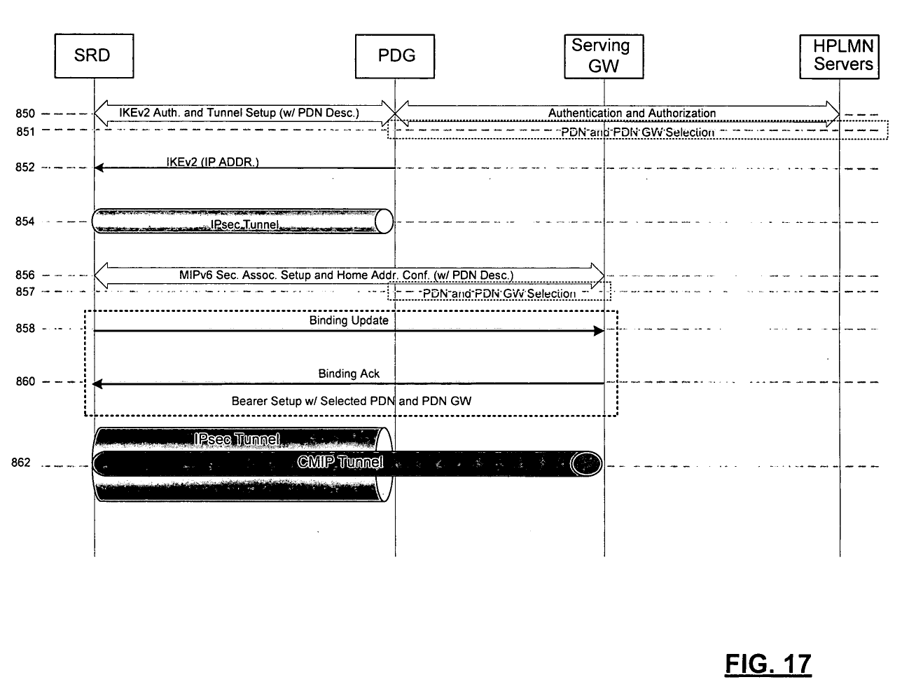

Referring now to FIGS. 16 and 17, a flow diagram and a message flow diagram illustrating a method of managing connectivity for wireless access in a network for untrusted access using a host-based mobility protocol are shown. The method may begin at 849.

When a SRD uses, for example CMIP, the SRD may send authentication information to a PDG via an AN in step 850. The authentication information may include a PDN descriptor. One of the remote servers receives the authentication information from the PDG, verifies the authentication information, and authorizes the SRD to access one or more remote networks. In step 851, which may be part of step 850, the PDG, the serving gateway, and/or the HPLMN servers may select the PDN, the PDN gateway and the IP services. This selection may also be performed during step 856.

The PDG may communicate with the SRD using an IKE protocol, such as IKEv2, in step 852 to set up a secure connectivity tunnel that connects the SRD to the PDG. Subsequently, the SRD initiates the setting up of an IP mobility tunnel in step 854. Security associations (SAs), which are cooperative relationships formed by exchanging security information, are set up to protect bi-directional traffic between the SRD and the PDG, in step 856.

During steps 858 and 860, a bearer corresponding to the SRD is setup based on the selected PDN and PDN gateway. The serving gateway binds the remote IP address to the home address of the SRD, and the SRD sends a binding update to one of the serving gateway in step 858. The SRD receives a binding acknowledgement from the serving gateway in step 860. The binding acknowledgement may be referred to as an attachment reply signal that indicates attachment completion based on the PDN descriptor.

The IP mobility tunnel, also referred to as a CMIP tunnel for the described embodiment, is set up between the SRD and the serving gateway in step 862. The CMIP tunnel begins at the SRD and ends at the serving gateway.

Referring now to FIG. 18, an example APN 870 is shown. An SRD may provide an indication of connectivity domain and IP service(s) preference by providing an APN. The APN 870 may include a PDN ID 871, a PDN gateway ID 872, IP service IDs 873 and/or a network system ID 874. The APN 870 may also include a domain name that identifies an operator, such as AT&T™ or T-mobile™. The network system identifier may indicate relationship of the APN 870 with a network system, such as a 3GPP™ network system. Each of the stated identifiers may be one or more bits in length.

Referring now to FIGS. 19 and 20, example FQDNs 880, 882 are respectively shown. The FQDN 880 includes a PDN ID 884, a PDN gateway ID 885, IP service IDs 886, and/or a VPLMN identifier 887. The FQDN 882 includes a PDN ID 890, a PDN gateway ID 891, IP service IDs 892, and/or a HPLMN identifier 893.

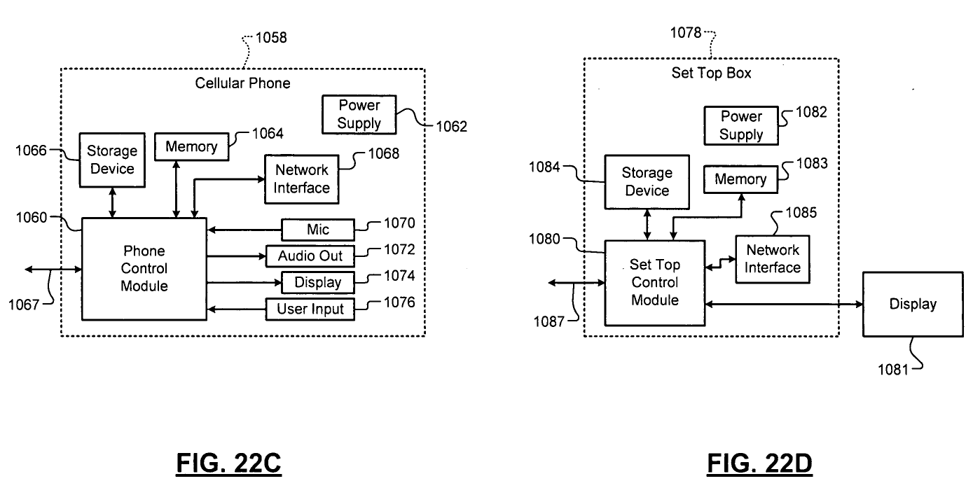

Referring now to FIG. 21, a logic flow diagram illustrating a method of providing a PDN descriptor is shown.

Terminal (SRD) exchange signaling with a wireless network may be performed to gain attachment including authentication and authorization and IP connectivity. This may be performed in a single step. The SRD provides a network with an indication of the type of PDN that the SRD prefers to be connected. The indication may be provided in a secure manner, such that the indication is not visible to other parties. The security may be provided when the exchange signaling is not secure. For example, the security may be provided when packets provided during an attachment, via a radio link between the SRD and the access network, are not encrypted.

To provide the indication in a secure manner indexing and/or a transformation function may be used. Indexing refers to the use of an index to determine a bearer data, PDN connection data, or other connectivity and service data that identifies a connectivity domain and/or IP service that a SRD prefers. A subscriber PDN mapping of index entries to bearer and/or PDN connection data may be stored in the SRD, the access network and/or in the remote network. The subscriber PDN mapping may be stored for example in the SRD and in one of the HPLMN servers disclosed herein and accessed by a MME, serving gateway, PDG, etc.

A transformation function may be applied to, for example, information that identifies a PDN connection (e.g., an APN, a FQDN, etc.). The result of the transformation function may be provided in a PDN descriptor. The transformation function and/or the technique to translate the result may be known to the SRD and a device of a network, such as a MME, a serving gateway, a PDG, a HPLMN server, etc. This prevents other parties from obtaining the identified SAE bearer or PDN connection.

An SRD and an access network or remote network may be configured with a list of bearer descriptors or PDN connection descriptors that the SRD may setup. The bearer descriptors may include SAE bearers and the PDN connection descriptors may include PDP contexts. The list of PDN connection descriptors may be part of subscriber data, such as GPRS subscriber data. For example SAE bearers and PDP contexts and corresponding structures see 3GPP™ TS 23.401, 3GPP™ TS 23.402 and 3GPP™ TS 23.060, which are incorporated herein by reference in their entirety. The PDN connection descriptors may have a logical APN identifier that refers to an APN.

The SRD, the access network, and/or the remote network may have the same subscriber data. The SRD may be configured by the access network and/or remote network to assure that the SRD and the networks have the same subscriber data. The SRD may be configured through use of a subscriber identity module (SIM) card that is inserted in the SRD or by over-the-air configuration techniques. The subscriber data includes a list of PDN connection descriptors that may include information that is commonly in a PDP context descriptor, such as bearer descriptors, a PDP address, mapping and routing information, etc.

The method may begin at 948. In step 950, the SRD selects the bearer or PDN connection desired. The selected bearer or PDN connection has a corresponding bearer ID or PDN connection ID.

In step 952, the SRD converts the bearer ID or the PDN connection ID into a PDN descriptor entry. In step 952A, the SRD may determine whether to proceed to step 952B1 or 952C1. This determination may be performed based on a level of security that the SRD desires. For example, when a security level is greater than a predetermined level, control proceeds to step 952B1, otherwise control proceeds to step 952C1.

In step 952B1, the SRD maps the selected bearer or PDN connection to an index value. The index value indicates which bearer or PDN connection in the list of PDN descriptors to use. In step 952B2, the SRD determines whether to perform a transfer function on the index value. When performing a transfer function, control proceeds to step 952B3, otherwise control proceeds to step 952D. In step 952B3, SRD selects and applies a transfer function, such as a hashing function, to the index value to generate a message digest. Examples of one-way hashing functions that may be used are message digest (MD)5 and secure hash algorithm (SHA)-1. See IETF RFC 1321 and IETF RFC 3174, which are incorporated herein by reference in their entirety. The transfer function selected prevents exposure of the bearer or PDN connection to other network nodes.

In step 952C1, the SRD may select and apply a transfer function, such as one of the transfer functions described above, to the selected bearer ID or PDN connection ID to generate a message digest. In step 952C2, the SRD determines whether to map the message digest to an index value. When mapping the message digest to an index value, control proceeds to step 952C3, otherwise control proceeds to step 952D. In step 952C3, the SRD maps the message digest to an index value. The index value indicates which transfer function results to use.

In step 952D, the SRD generates a PDN descriptor. The PDN descriptor may include an index value or a message digest. In step 954, generate an attachment request with the PDN descriptor. In step 956, a network node, such as a network device of one of the networks, receives an attachment request from the SRD and may download the subscriber data as part of the attachment procedure. The subscriber data may include the bearer data, the PDN connection data, the index values, etc.

In step 958, the network node converts the PDN descriptor into bearer or PDN connection data. In step 958a, the network node may perform indexing and look-up an index value in the subscriber data to obtain the bearer or PDN connection data. In step 958b1, the network node may perform a transfer function on subscriber data. As an example, the network node may calculate hashes on content of the subscriber data. In step 958, the network node compares the results of step 958B1 to the PDN descriptor to obtain the bearer or PDN connection data. In step 960, the network node uses the bearer or PDN connection data to setup a bearer or PDN connection.

The above-described steps in the above-described Figures are meant to be illustrative examples; the steps may be performed sequentially, synchronously, simultaneously, continuously, during overlapping time periods or in a different order depending upon the application. Also, the above-described methods may be applied to a network system that supports multiple PDNs through use of multiple. PDN gateways.

The embodiments disclosed herein provide system architectures that support both host-based IP mobility management (CMIP) and network-based mobility management (PMIP). The system architectures support CMIP-capable SRDs, PMIP-capable SRDs, and CIMP/PMIP-capable SRDs. Thus, system architectures apply to networks that support PMIP and/or CMIP based handovers.

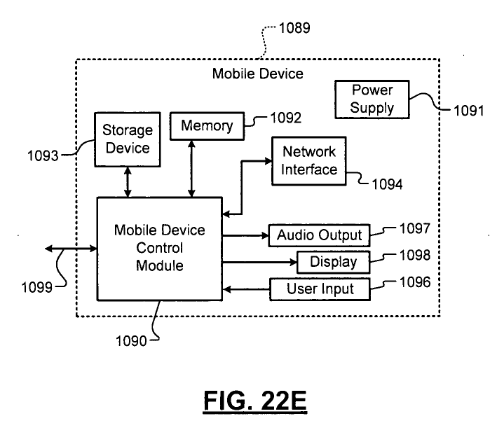

Referring now to FIGS. 22A-22E, various exemplary implementations incorporating the teachings of the present disclosure are shown.

Referring now to FIG. 22A, the teachings of the disclosure can be implemented in a network interface 1043 of a high definition television (HDTV) 1037. The HDTV 1037 includes an HDTV control module 1038, a display 1039, a power supply 1040, memory 1041, a storage device 1042, the network interface 1043, and an external interface 1045. If the network interface 1043 includes a wireless local area network interface, an antenna (not shown) may be included.

The HDTV 1037 can receive input signals from the network interface 1043 and/or the external interface 1045, which can send and receive data via cable, broadband Internet, and/or satellite. The HDTV control module 1038 may process the input signals, including encoding, decoding, filtering, and/or formatting, and generate output signals. The output signals may be communicated to one or more of the display 1039, memory 1041, the storage device 1042, the network interface 1043, and the external interface 1045.

Memory 1041 may include random access memory (RAM) and/or nonvolatile memory. Nonvolatile memory may include any suitable type of semiconductor or solid-state memory, such as flash memory (including NAND and NOR flash memory), phase change memory, magnetic RAM, and multi-state memory, in which each memory cell has more than two states. The storage device 1042 may include an optical storage drive, such as a DVD drive, and/or a hard disk drive (HDD). The HDTV control module 1038 communicates externally via the network interface 1043 and/or the external interface 1045. The power supply 1040 provides power to the components of the HDTV 1037.

Referring now to FIG. 22B, the teachings of the disclosure may be implemented in a network interface 1052 of a vehicle 1046. The vehicle 1046 may include a vehicle control system 1047, a power supply 1048, memory 1049, a storage device 1050, and the network interface 1052. If the network interface 1052 includes a wireless local area network interface, an antenna (not shown) may be included. The vehicle control system 1047 may be a powertrain control system, a body control system, an entertainment control system, an anti-lock braking system (ABS), a navigation system, a telematics system, a lane departure system, an adaptive cruise control system, etc.

The vehicle control system 1047 may communicate with one or more sensors 1054 and generate one or more output signals 1056. The sensors 1054 may include temperature sensors, acceleration sensors, pressure sensors, rotational sensors, airflow sensors, etc. The output signals 1056 may control engine operating parameters, transmission operating parameters, suspension parameters, braking parameters, etc.

The power supply 1048 provides power to the components of the vehicle 1046. The vehicle control system 1047 may store data in memory 1049 and/or the storage device 1050. Memory 1049 may include random access memory (RAM) and/or nonvolatile memory. Nonvolatile memory may include any suitable type of semiconductor or solid-state memory, such as flash memory (including NAND and NOR flash memory), phase change memory, magnetic RAM, and multi-state memory, in which each memory cell has more than two states. The storage device 1050 may include an optical storage drive, such as a DVD drive, and/or a hard disk drive (HDD). The vehicle control system 1047 may communicate externally using the network interface 1052.

Referring now to FIG. 22C, the teachings of the disclosure can be implemented in a network interface 1068 of a cellular phone 1058. The cellular phone 1058 includes a phone control module 1060, a power supply 1062, memory 1064, a storage device 1066, and a cellular network interface 1067. The cellular phone 1058 may include the network interface 1068, a microphone 1070, an audio output 1072 such as a speaker and/or output jack, a display 1074, and a user input device 1076 such as a keypad and/or pointing device. If the network interface 1068 includes a wireless local area network interface, an antenna (not shown) may be included.

The phone control module 1060 may receive input signals from the cellular network interface 1067, the network interface 1068, the microphone 1070, and/or the user input device 1076. The phone control module 1060 may process signals, including encoding, decoding, filtering, and/or formatting, and generate output signals. The output signals may be communicated to one or more of memory 1064, the storage device 1066, the cellular network interface 1067, the network interface 1068, and the audio output 1072.

Memory 1064 may include random access memory (RAM) and/or nonvolatile memory. Nonvolatile memory may include any suitable type of semiconductor or solid-state memory, such as flash memory (including NAND and NOR flash memory), phase change memory, magnetic RAM, and multi-state memory, in which each memory cell has more than two states. The storage device 1066 may include an optical storage drive, such as a DVD drive, and/or a hard disk drive (HDD). The power supply 1062 provides power to the components of the cellular phone 1058.

Referring now to FIG. 22D, the teachings of the disclosure can be implemented in a network interface 1085 of a set top box 1078. The set top box 1078 includes a set top control module 1080, a display 1081, a power supply 1082, memory 1083, a storage device 1084, and the network interface 1085. If the network interface 1085 includes a wireless local area network interface, an antenna (not shown) may be included.

The set top control module 1080 may receive input signals from the network interface 1085 and an external interface 1087, which can send and receive data via cable, broadband Internet, and/or satellite. The set top control module 1080 may process signals, including encoding, decoding, filtering, and/or formatting, and generate output signals. The output signals may include audio and/or video signals in standard and/or high definition formats. The output signals may be communicated to the network interface 1085 and/or to the display 1081. The display 1081 may include a television, a projector, and/or a monitor.

The power supply 1082 provides power to the components of the set top box 1078. Memory 1083 may include random access memory (RAM) and/or nonvolatile memory. Nonvolatile memory may include any suitable type of semiconductor or solid-state memory, such as flash memory (including NAND and NOR flash memory), phase change memory, magnetic RAM, and multi-state memory, in which each memory cell has more than two states. The storage device 1084 may include an optical storage drive, such as a DVD drive, and/or a hard disk drive (HDD).

Referring now to FIG. 22E, the teachings of the disclosure can be implemented in a network interface 1094 of a mobile device 1089. The mobile device 1089 may include a mobile device control module 1090, a power supply 1091, memory 1092, a storage device 1093, the network interface 1094, and an external interface 1099. If the network interface 1094 includes a wireless local area network interface, an antenna (not shown) may be included.

The mobile device control module 1090 may receive input signals from the network interface 1094 and/or the external interface 1099. The external interface 1099 may include USB, infrared, and/or Ethernet. The input signals may include compressed audio and/or video, and may be compliant with the MP3 format. Additionally, the mobile device control module 1090 may receive input from a user input 1096 such as a keypad, touchpad, or individual buttons. The mobile device control module 1090 may process input signals, including encoding, decoding, filtering, and/or formatting, and generate output signals.

The mobile device control module 1090 may output audio signals to an audio output 1097 and video signals to a display 1098. The audio output 1097 may include a speaker and/or an output jack. The display 1098 may present a graphical user interface, which may include menus, icons, etc. The power supply 1091 provides power to the components of the mobile device 1089. Memory 1092 may include random access memory (RAM) and/or nonvolatile memory.

Nonvolatile memory may include any suitable type of semiconductor or solid-state memory, such as flash memory (including NAND and NOR flash memory), phase change memory, magnetic RAM, and multi-state memory, in which each memory cell has more than two states. The storage device 1093 may include an optical storage drive, such as a DVD drive, and/or a hard disk drive (HDD). The mobile device may include a personal digital assistant, a media player, a laptop computer, a gaming console, or other mobile computing device.

The broad teachings of the disclosure can be implemented in a variety of forms. Therefore, while this disclosure includes particular examples, the true scope of the disclosure should not be so limited since other modifications will become apparent upon a study of the drawings, the specification, and the following claims.

What is claimed is:

1. A network device comprising:
a receive module that receives a PDN descriptor that includes at least one of a PDN identifier and a PDN gateway identifier from a remote device before bearer setup of the remote device by the network device;
a control module that generates a reply signal that indicates said bearer setup based on said PDN descriptor; and
a transmit module that transmits said reply signal to said remote device.

2. The network device of claim 1 wherein said bearer setup includes at least one of attachment and Internet protocol (IP) connectivity setup of the remote device.

3. The network device of claim 2 wherein said attachment includes authentication and authorization of the network device.

4. The network device of claim 3 wherein said attachment includes at least one of generation of a bearer context, registration of the network device, and a binding update of the remote device.

5. The network device of claim 4 wherein said bearer context includes an address for an Internet session of the remote device.

6. The network device of claim 2 wherein said IP connectivity setup includes at least one of a serving gateway, a packet data gateway, and a PDN gateway.

7. The network device of claim 1 wherein said control module enables said bearer setup based on selection of at least one of a PDN and a PDN gateway, and
wherein said selection is based on said PDN descriptor.

8. The network device of claim 7 wherein said control module includes at least one of a mobility management entity control module, a serving gateway control module, and a home subscriber server control module, and
wherein said control module selects said at least one of a PDN and a PDN gateway based on said PDN descriptor.

9. The network device of claim 1 wherein said PDN descriptor includes said PDN gateway identifier; and
wherein said PDN gateway identifier identifies a PDN gateway in a network of the network device.

10. The network device of claim 9 wherein said control module establishes a tunnel for communication with said PDN gateway based on said reply signal.

11. The network device of claim 1 wherein said PDN descriptor is indicative of a connectivity domain and Internet protocol services selected by the network device.

12. The network device of claim 1 wherein said PDN descriptor includes an Internet protocol (IP) service identifier.

13. The network device of claim 1 wherein said PDN descriptor includes an index value, and
wherein said control module determines at least one of a PDN, a PDN gateway, PDN connection data, and bearer data based on said index value.

14. The network device of claim 1 wherein said receive module receives a transfer function output based on an index value, and
wherein said control module determines at least one of a PDN, a PDN gateway, PDN connection data, and bearer data based on said transfer function output.

15. The network device of claim 1 wherein said receive module receives a transfer function output based on at least one of a PDN identifier, a PDN gateway identifier, and an Internet service identifier, and
wherein said control module determines at least one of a PDN, a PDN gateway, PDN connection data, and bearer data based on said transfer function output.

16. The network device of claim 15 wherein said transfer function includes a hashing transfer function.

17. The network device of claim 15 wherein said receive module receives an index value based on said transfer function value, and
wherein said control module determines at least one of a PDN, a PDN gateway, PDN connection data, and bearer data based on said index value.

18. The network device of claim 1 wherein said receive module receives at least one of an access point name and a domain name that includes said PDN descriptor, and
wherein said transmit module transmits said reply signal based on said at least one of an access point name and a domain name.

19. The network device of claim 1 wherein said receive module receives said PDN descriptor during an attachment procedure of the remote device.

20. The network device of claim 1 wherein said control module generates a bearer context request based on said PDN descriptor,
wherein said transmit module transmits said bearer context request to at least one of a serving gateway and a PDN gateway; and
wherein said receive module receives a bearer context response based on said bearer context request signal.

21. The network device of claim 1 wherein said receive module receives an attachment request signal that includes said PDN descriptor, and
wherein said transmit module transmits an attachment accept signal generated by a mobility management entity based on said attachment request signal.

22. The network device of claim 1 wherein said receive module receives said PDN descriptor during authentication of the remote device by a network that is remote to said remote device.

23. The network device of claim 1 wherein said receive module receives said PDN descriptor during a registration of the remote device with the network device.

24. The network device of claim 1 wherein said transmit module transmits a registration reply signal based on selection of at least one of a PDN and a PDN gateway corresponding to identifiers of said PDN descriptor.

25. The network device of claim 1 wherein said transmit module transmits a binding acknowledgement signal based on selection of at least one of a PDN and a PDN gateway corresponding to identifiers of said PDN descriptor.
